(19) United States
(12) Patent Application Publication
(10) Pub. No.: US 2011/0119259 A1
(43) Pub. Date: May 19, 2011

(54) NETWORK BIOLOGY APPROACH FOR IDENTIFYING TARGETS FOR COMBINATION THERAPIES

(75) Inventors: James J. Collins, Newton, MA (US); Zheng Li, St. Louis, MO (US); Ayla Ergun, Brookline, MA (US)

(73) Assignee: TRUSTEES OF BOSTON UNIVERSITY, Boston, MA (US)

(21) Appl. No.: 12/989,083

(22) PCT Filed: Apr. 24, 2009
(86) PCT No.: PCT/US09/41612

§ 371 Date: Jan. 13, 2011

Related U.S. Application Data
(62) Division of application No. 61/047,607, filed on Apr. 24, 2008.

(51) Int. Cl. G06F 17/30

(52) U.S. Cl. 707/723; 707/E17.014

(57) ABSTRACT

Described herein is a network biology approach useful for the identification of multiple therapeutic targets, which can be targeted simultaneously using an agent (or a plurality of agents) to modulate cellular phenotypes, or in combination with pharmaceutical compounds to improve drug sensitivity and/or reduce drug doses to maintain efficacy while minimizing side effects. The preferred approach disclosed herein relies on first identifying the mediators of a condition of interest, and second, selecting gene combinations that are in competing/parallel pathways as targets for combination therapy.

### CROSS REFERENCE TO RELATED APPLICATION

This application claims benefit under 35 U.S.C. §119(e) of the U.S. Provisional Application No. 61/047,607 filed Apr. 24, 2008, the contents of which are incorporated herein by reference in its entirety.

### GOVERNMENT SUPPORT

This invention was made with Government Support under Contract No. OD003644 awarded by the National Institutes of Health. The Government has certain rights in the invention.

### FIELD OF THE INVENTION

The present invention relates to the field of drug discovery. In particular, the invention utilizes a network biology approach to identify targets for combination therapy.

### BACKGROUND

Many disease states arise from complex networks of interacting genes, proteins and small molecules. Multiple components are usually involved, and they need to be perturbed in combination to achieve the best effects for modulating a cellular phenotype [1]. Therefore, it is important to understand diseases in the context of networks in order to identify key components, which if targeted together might have improved phenotypic consequences.

The traditional approach to treating diseases has been to target a single mediator with the hopes of eradicating or stopping the progression of the disease. For example, chemotherapy has been successfully applied in clinical treatment of many cancers including hematologic malignancies and solid tumors. However, the effectiveness of chemotherapy is limited due to drug resistance that is either intrinsic to cancer cells or acquired during the treatment process [2]. In addition, clinical drug dose usage has been limited in many cases due to side effects such as drug toxicity. In order to achieve minimal side effects and optimal therapeutic effects simultaneously, multiple drugs could be applied in combination to hit multiple targets with non-overlapping side effects and complementary therapeutic effects.

The pharmaceutical industry has historically relied upon particular families of “druggable” proteins, which consists of a limited number of mediators that could be regulating a disease of interest. In order to design the most effective combination therapies, RNAi technology can also be considered, which can selectively silence essentially any gene in the genome.

Microarray gene expression data provides informative profiling of biological processes and states in a cell, which makes possible, with the help of systems biology approaches, the systematic identification of disease mediators. Presented herein is a systems biology platform that can be used to identify disease mediators in the context of networks, which if targeted together can provide better therapies for treatment of a disease of interest. Disclosed herein is a description of how the network biology approach can be applied to identify disease mediators, and second, how the identified mediators can be used to design combination therapies using RNAi and/or drug compounds.

### SUMMARY OF THE INVENTION

Described herein are methods for the identification of genes and gene products to target for the treatment of disease. In preferred aspects, the methods described herein permit the identification of genes or gene products which, when modulated by a drug or other treatment, can enhance the therapeutic efficacy of another drug or treatment. In particular, the methods described herein are well-suited for the identification of drug targets that modify the response of an organism, e.g., a human, to a first drug. By identifying biochemical pathways involved in a given disease and/or drug response, the methods described herein permit the selection of pathway elements or members, the modulation of which can modify the response to that drug. As but one example, where the administration of a first drug induces a host response that increases the rate of metabolism of that drug to a non-active form, treatment with a second drug that modifies that host response can potentially enhance the effect of the first drug. Similar benefits can be gained where, for example, the pathways involved in a side-effect of a first drug are identified. Targeting of a pathway involved in the undesirable side effect can be targeted with a second drug or treatment can reduce that side effect, while maintaining the beneficial effect of the first drug. Such approaches can provide benefits in both enhanced drug efficacy, as well as potentially reducing the dosage of particular drugs required, which can have benefits of reduced cost and reduced potential for undesirable side effects.

An objective of the methods and systems described herein is therefore to identify multiple therapeutic targets, which can be targeted simultaneously to modulate cellular phenotypes, or in combination with pharmaceutical compounds to improve the drug sensitivity and/or reduce the drug doses for minimal side effects. The approach disclosed herein relies on first identifying the mediators of a condition of interest, and second, selecting gene combinations that are in competing and/or parallel pathways. While any approach for the modulation of target genes or gene products can be applied in the methods described herein (e.g., small molecule drugs, antibodies or antibody fragments, inhibitory peptides, aptamers, PNAs, etc.), RNAi-based approaches to reducing the expression of target genes are attractive in that essentially any gene can be specifically targeted using RNAi-based approaches.

In the methods described herein, a computer-implemented network biology approach is applied, namely, mode-of-action by network identification (MNI) [3, 4], to reverse-engineer a gene regulatory network from a compendium of microrray gene expression profiles. This network is then used in a computer-implemented way as a filter to identify mediators of a disease. Computer-implemented enrichment analysis is then performed on the top ranked mediator genes to identify enriched pathways that aid in the design of the combination therapy. The network biology approach is exemplified in two case studies demonstrating its effectiveness of this approach, described herein in the Examples section: (1) gene targets were identified for modulating drug sensitivity of chemotherapy for treating childhood acute lymphoblastic leukemia (ALL), and (2) gene targets were identified for modulating cancerous phenotypes in hepatocellular carcinoma. The approaches described herein are widely applicable to the determination of drug combinations for the treatment of diseases or disorders. The methods described herein can be adapted, for example, to predict synergistic drug combinations for the treatment of a disease, or to enhance the efficacy of a drug for the treatment of a disease, or to tailor a drug therapy to an individual.

In one aspect, described herein is a computer-implemented method comprising (a) filtering a test gene expression data set from a sample through a reverse engineered gene regulatory network derived for an organism to identify a set of candidate target genes at a computer processor; (b) assigning a z-score to each target gene in the set of candidate target genes, and ranking the target genes according to the z-score at the computer processor; (c) creating a set of enriched target genes with the highest z-scores using gene ontology enrichment analysis or pathway database search at the computer processor.

In one embodiment of this aspect and all other aspects described herein, the reverse engineered gene regulatory network is derived from a compendium of gene expression data sets derived from the organism.

In another embodiment of this aspect and all other aspects described herein, the method comprises constructing the reverse engineered gene regulatory network at the computer processor, and wherein construction of the reverse engineered gene regulatory network comprises: (a) providing a biological system or a plurality of biological systems, each biological system comprising a biological network comprising a plurality of biochemical species having activities;

(b) perturbing the activity of at least one of the biochemical species, thereby causing a response in the biological network; (c) allowing the biological network to reach a steady state;
(d) determining the response of at least one of the biochemical species in the biological network; and
(e) estimating parameters of a model representing the biological network, whereby the reverse-engineered gene regulatory network is constructed.

In another embodiment of this aspect and all other aspects described herein, the compendium of gene expression data sets comprises gene expression data from a plurality of conditions of the organism.

In another embodiment of this aspect and all other aspects described herein, the pathway database search comprises searching pathway maps or applying a pathway analysis.

In another embodiment of this aspect and all other aspects described herein, the method further comprises targeting a candidate disease-mediator gene of the set of candidate disease-mediator genes for modulation with an agent.

In another embodiment of this aspect and all other aspects described herein, the method further comprises targeting a candidate disease-mediator gene of the set of candidate disease-mediator genes for modulation with a plurality of agents.

In another embodiment of this aspect and all other aspects described herein, the method further comprises targeting a plurality of candidate disease-mediator genes for modulation with an agent, or a plurality of agents.

In another embodiment of this aspect and all other aspects described herein, the modulation comprises inhibition of the candidate disease-mediator gene.

In another embodiment of this aspect and all other aspects described herein, the inhibition comprises treating a subject with an agent selected from the group consisting of an RNA interference molecule, a small molecule, an antibody or antigen-binding fragment thereof, a peptide, a polypeptide, an oligonucleotide, an aptamer, a peptide nucleic acid, or a nucleic acid.

In another embodiment of this aspect and all other aspects described herein, enriching those target genes with the highest z-scores comprises enriching a set of 100 to 300 genes with the highest z-scores.

In another embodiment of this aspect and all other aspects described herein, the enriching step identifies a set of candidate disease-mediator genes.

In another embodiment of this aspect and all other aspects described herein, the enriching step provides an enriched set of candidate drug-influenced genes

In another embodiment of this aspect and all other aspects described herein, the enriched set of candidate drug-influenced genes represents potential therapy targets that are predicted to have a combined efficacy for treating a given disease that is greater than the added efficacy of each agent alone.

In another embodiment of this aspect and all other aspects described herein, the sample represents a disease population, and wherein increasing z-scores correlate with increasing likelihood of direct participation in disease pathology.

In another embodiment of this aspect and all other aspects described herein, the sample is derived from an individual or set of individuals treated with a first drug, and wherein increasing z-scores correlate with increasing likelihood of direct influence by treatment with the first drug.

In another embodiment of this aspect and all other aspects described herein, the sample is derived from a subject or set of subjects treated with a first drug, and wherein the set of candidate genes that are identified are genes that are modulated in an individual following treatment with a first drug.

In another embodiment of this aspect and all other aspects described herein, the enriching step provides an enriched set of candidate drug-influenced genes representing genes predicted to be involved in an individual's response to the first drug.

In another embodiment of this aspect and all other aspects described herein, the method further comprises: (d) administering to an individual in need of treatment for a the disease the first drug and an agent that modulates a gene or product thereof represented in the enriched set of candidate drug-influenced genes, wherein modulation of the gene enhances the efficacy of the first drug for the treatment of the disease.

In another embodiment of this aspect and all other aspects described herein, efficacy of the first drug is enhanced by increasing the in vivo half-life of the first drug.

In another embodiment of this aspect and all other aspects described herein, efficacy of the first drug is enhanced by slowing metabolism of the first drug.

In another embodiment of this aspect and all other aspects described herein, efficacy of the first drug is enhanced by decreasing clearance of the first drug.

In another embodiment of this aspect and all other aspects described herein, efficacy of the first drug is enhanced by decreasing a side effect of the first drug.

In another embodiment of this aspect and all other aspects described herein, efficacy of the first drug is enhanced by increasing bioavailability of the first drug.

In another embodiment of this aspect and all other aspects described herein, the sample is derived from an individual treated with a first drug, and wherein a set of candidate gene targets that are upregulated in the individual are identified.

In another embodiment of this aspect and all other aspects described herein, the enriching provides an enriched set of candidate drug-influenced genes representing genes predicted to be involved in an individual's response to the first drug.

In another embodiment of this aspect and all other aspects described herein, administering the first drug and an agent that modulates the activity of a candidate drug-influenced gene or a product thereof to the individual, wherein the administering enhances the response of the individual to the first drug.

In another aspect, described herein is a computer readable storage medium containing executable instructions which cause a data processing system to perform a method, the instructions comprising: (a) instructions for receiving test gene expression data from a sample obtained from an organism; (b) instructions for filtering the test gene expression data through a reverse engineered gene regulatory network derived for the organism to identify a set of candidate target genes; (c) instructions for assigning a z-score to each target gene in the set of candidate target genes, and ranking the target genes according to z-score; and (d) instructions for enriching those target genes with the highest z-scores using gene ontology enrichment analysis or pathway database search

In another embodiment of this aspect and all other aspects described herein, the sample represents a disease population and the increasing z-scores correlate with increasing likelihood of direct participation in disease pathology, and further comprising: (e)

instructions for outputting identities of a set of candidate disease-mediator genes to a computer-readable memory or to an output device.

In another embodiment of this aspect and all other aspects described herein, the sample is derived from an individual or set of individuals treated with a first drug and the increasing z-scores correlate with increasing likelihood of direct influence by treatment with the first drug, and further comprising: (e) instructions for outputting identities of an enriched set of candidate drug-influenced genes to a computer-readable memory or to an output device.

In another embodiment of this aspect and all other aspects described herein, the sample is derived from a subject or set of subjects treated with a first drug and increasing z-scores correlate with increasing likelihood of direct influence by the first drug, and further comprising: (e) instructions for outputting identities of an enriched set of candidate drug influenced genes representing a set of candidate targets for enhancing the efficacy of the first drug.

In another embodiment of this aspect and all other aspects described herein, the sample is derived from an individual treated with a first drug, and further comprising: (e) instructions for outputting identities of an enriched set of candidate drug influenced genes represents genes predicted to be involved in an individual's response to the first drug.

In another aspect, described herein is a computer system for identifying candidate disease mediator genes, the computer system comprising: (a) memory configured to store test gene expression data from a sample obtained from an organism; and (b) a computer processor coupled to the memory and configured to filter the test gene expression data through a reverse engineered gene regulatory network derived for the organism to identify a set of candidate target genes, assign a z-score to each target gene in the set of candidate target genes, rank the target genes according to z-score, and enrich those target genes with the highest z-scores using gene ontology enrichment analysis or pathway database search.

In another embodiment of this aspect and all other aspects described herein, the sample represents a disease population, the increasing z-scores correlate with increasing likelihood of direct participation in disease pathology, and wherein the computer processor is further configured to store data regarding a set of identified candidate disease-mediator genes.

In another embodiment of this aspect and all other aspects described herein, the sample is derived from an individual or set of individuals treated with a first drug and the increasing z-scores correlate with increasing likelihood of direct influence by treatment with the first drug, and wherein the computer processor is further configured to store data regarding an enriched set of candidate drug-influenced genes.

In another embodiment of this aspect and all other aspects described herein, the sample is derived from a subject or set of subjects treated with a first drug and increasing z-scores correlate with increasing likelihood of direct influence by the first drug, and wherein the computer processor is further configured to store data regarding a set of identified candidate targets representing a set of candidate targets for enhancing the efficacy of the first drug.

In another embodiment of this aspect and all other aspects described herein, the sample is derived from an individual treated with a first drug, and wherein the computer processor is further configured to store data regarding a set of candidate targets representing genes predicted to be involved in an individual's response to the first drug.

In another aspect, described herein is a method for identifying candidate disease mediator genes, the method comprising the steps of: (a) filtering a test gene expression data set from a sample representing a disease population through a reverse engineered gene regulatory network derived for an organism to identify a set of candidate target genes; (b) assigning a z-score to each target gene in the set of candidate target genes, and ranking the target genes according to z-score, wherein increasing z-scores correlate with increasing likelihood of direct participation in disease pathology; and (c) enriching those target genes with the highest z-scores for those most likely to be directly involved in the disease using gene ontology enrichment analysis or pathway database search, wherein the enriching identifies a set of candidate disease-mediator genes.

In one embodiment of this and other aspects described herein, the reverse engineered gene regulatory network is derived from a compendium of gene expression data sets derived from the organism. Generally, the larger and more diverse the compendium, the more sensitive the network model is for the identification of candidate disease- or response-mediator genes. Thus, in another embodiment of this and other aspects described herein, the compendium of gene expression data sets comprises gene expression data from a plurality of conditions of the organism. A compendium useful for the methods described herein will generally comprise data sets representing a large number of different conditions or perturbations of a given system. In various embodiments of this and other aspects described herein, the compendium can include, for example, at least 50 data sets or more, but it is preferred that the compendium include at least 100 or more, at least 200 or more, at least 300 or more, at least 400 or more, at least 500 or more, at least 600 or more gene expression data sets or profiles. Examples include gene expression profiles obtained from cells, tissues, organs or individuals treated with a range of different drugs or stimuli, e.g., cells treated with a range of different drugs, agents or external stimuli (such as temperature or other environmental condition, nutrient availability, etc.) preferably of different classes, as well as profiles from cells, tissues or organs from individuals suffering from a disease or condition, e.g., cancer, infection, hypertension, inflammation, neurodegenerative disease, atherosclerosis, organ failure, etc.

It is preferred, but not absolutely required, that the members of a compendium of data sets are obtained from the same or similar gene or protein expression analysis platform. For example, one of the most common platforms is a microarray platform, e.g., an Affymetrix or other supplier's microarray gene chip. Other gene expression profiling approaches known to those of skill in the art are equally applicable for the generation of data included in a compendium. In one embodiment of this and other aspects described herein, the data in a compendium are harvested from existing gene expression profile databases. In other embodiments of this and other aspects described herein, the compendium can include or be created by performing new gene expression profiling analyses.

The reverse engineered gene regulatory network can be derived from a compendium using methods known in the art and described herein below. For example, U.S. pre-grant patent publication No. US 2006/0293873, which is incorporated herein by reference in its entirety, describes systems and methods for reverse-engineering models of biological networks. See also Ergün et al., 2007, Mol. Syst. Biol. 3: 82 and diBernardo et al., 2005, Nature Biotech. 23: 377-383, also incorporated herein in their entireties. In one embodiment of this and other aspects described herein, the reverse engineered gene regulatory network is constructed using the steps of: (a) providing a biological system or a plurality of biological systems, each biological system comprising a biological network comprising a plurality of biochemical species having activities; (b) perturbing the activity of at least one of the biochemical species, thereby causing a response in the biological network; (c) allowing the biological network to reach a steady state; (d) determining the response of at least one of the biochemical species in the biological network; and (e) estimating parameters of a model representing the biological network, whereby the reverse-engineered gene regulatory network is constructed. This approach is described in detail in US 2006/0293873.

In another embodiment of this and other aspects described herein, the pathway database search comprises searching pathway maps or applying a pathway analysis. Various pathway databases exist and can be searched against high scoring candidate genes identified by filtering gene expression data sets through a reverse-engineered gene regulatory network. Examples of such pathway searching and analysis databases or packages include Ingenuity Pathways Analysis (IPA)™ from Ingenuity Systems, Inc., as well as a number of different pathway construction and analysis packages described at http://ihome.cuhk.edu.hk/˜b400559/arraysoft_pathway.html. Examples of these include BioMiner, Cytoscape, DBmcmc, Dynamic Signaling Maps, Genetic Network Analyzer (GNA), GenMAPP, GenePath, Graphviz, GSCope, INCLUSive, InterViewer3, KnowledgeEditor, Osprey, PathFinder, Pathtracker, Pathway Editor, Pathway Assist, Pathway Finder, Pathway Processor, PubGene, Subnetwork hierarchies (Holme et al., 2003, Bioinformatics 19: 532-538) and Vector PathBlazer.

In another embodiment, the method of this and other aspects described herein further comprises targeting a candidate disease-mediator gene of the set of candidate disease-mediator genes for modulation with an agent. In another embodiment, the method of this and other aspects described herein further comprises targeting a candidate disease-mediator gene of the set of candidate disease-mediator genes for modulation with a plurality of agents. In another embodiment, the method of this and other aspects described herein further comprises targeting a plurality of candidate disease-mediator genes for modulation with an agent, or a plurality of agents.

In one embodiment of this and other aspects described herein, the “modulation” comprises inhibition of the candidate disease-mediator gene. The inhibition can comprise, for example, treating a subject with an agent selected from the group consisting of an RNA interference molecule, a small molecule, an antibody or antigen-binding fragment thereof, a peptide, a polypeptide, an oligonucleotide, an aptamer, a peptide nucleic acid, or a nucleic acid.

In one embodiment of this and other aspects described herein, the step of enriching of those target genes with the highest z-scores comprises enriching a set of the 100 to 300 genes with the highest z-scores.

In another aspect, described herein is a method for predicting synergistic drug combinations for treating a given disease, the method comprising the steps of: (a) filtering a test gene expression data set from a sample derived from an individual or set of individuals treated with a first drug through a reverse engineered gene regulatory network derived for an organism to identify a set of candidate genes influenced by the first drug; (b) assigning a z-score to each candidate gene in the set of candidate genes, and ranking the candidate genes according to z-score, wherein increasing z-scores correlate with increasing likelihood of direct influence by treatment with the first drug; (c) enriching those candidate genes with the highest z-scores using gene ontology enrichment analysis or pathway database search, wherein the enriching provides an enriched set of candidate drug-influenced genes, and wherein the enriched set of candidate drug-influenced genes represents potential therapy targets that are predicted to have a combined efficacy for treating a given disease that is greater than the added efficacy of each agent alone.

In another aspect, described herein is a method for enhancing efficacy of a drug used to treat a given disease, the method comprising the steps of: (a) filtering a test gene expression data set from a sample derived from a subject or set of subjects treated with a first drug through a reverse engineered gene regulatory network derived for an organism to identify a set of candidate genes that are modulated in the individual following treatment with a first drug; (b) assigning a z-score to each gene in the set of candidate genes, and ranking the candidate genes according to z-score, wherein increasing z-scores correlate with increasing likelihood of direct influence by the first drug; (c) enriching those candidate genes with the highest z-scores using gene ontology enrichment analysis or pathway database search, wherein the enriching provides an enriched set of candidate drug-influenced genes representing genes predicted to be involved in an individual's response to the first drug; and (d) administering to an individual in need of treatment for the disease the first drug and an agent that modulates a gene or product thereof represented in the enriched set of candidate drug-influenced genes, wherein modulation of the gene enhances the efficacy of the first drug for the treatment of the disease.

In one embodiment, the efficacy of the first drug is enhanced by increasing the in vivo half-life of the first drug. In another embodiment, the efficacy of the first drug is enhanced by slowing metabolism of the first drug. In another embodiment, the efficacy of the first drug is enhanced by decreasing clearance of the first drug. In another embodiment, the efficacy of the first drug is enhanced by decreasing a side effect of the first drug. In another embodiment, the efficacy of the first drug is enhanced by increasing bioavailability of the first drug.

In another aspect, described herein is a method for tailoring a drug therapy to an individual, the method comprising the steps of: (a) filtering a gene expression data set from a sample derived from an individual treated with a first drug through a reverse engineered gene regulatory network derived for an organism to identify a set of candidate gene targets that are upregulated in the individual; (b) assigning a z-score to each target gene in the set of candidate gene targets, and ranking the target genes according to z-score; (c) enriching the target genes with highest z-score using gene ontology enrichment analysis or pathway database search, wherein the enriching provides an enriched set of candidate drug-influenced genes representing genes predicted to be involved in an individual's response to the first drug; and (d) administering the first drug and an agent that modulates the activity of a candidate drug-influenced gene or a product thereof to the individual, wherein the administering enhances the response of the individual to the first drug.

In another aspect, encompassed herein is a computer-readable medium comprising computer-executable instructions for identifying a set of candidate disease mediator genes, the medium comprising: (a) instructions for receiving test gene expression data from a sample representing a disease population of an organism; (b) instructions for filtering the test gene expression through a reverse engineered gene regulatory network derived for the organism to identify a set of candidate target genes; (c) instructions for assigning a z-score to each target gene in the set of candidate target genes, and ranking the target genes according to z-score, wherein increasing z-scores correlate with increasing likelihood of direct participation in disease pathology; (d) instructions for enriching those target genes with the highest z-scores for those most likely to be directly involved in the disease using gene ontology enrichment analysis or pathway database search, wherein the enriching identifies a set of candidate disease-mediator genes; and (e) instructions for outputting the identities of the set of candidate disease-mediator genes to a computer-readable memory or to an output device.

In another aspect, encompassed herein is a computer system for identifying candidate disease mediator genes, the computer system comprising: (a) a user interface; (b) a computer processor capable of executing computer executable instructions encoded on a computer-readable medium; (c) a computer readable medium comprising: (i) instructions for receiving test gene expression data from a sample representing a disease population of an organism; (ii) instructions for filtering the test gene expression through a reverse engineered gene regulatory network derived for the organism to identify a set of candidate target genes; (iii) instructions for assigning a z-score to each target gene in the set of candidate target genes, and ranking the target genes according to z-score, wherein increasing z-scores correlate with increasing likelihood of direct participation in disease pathology; (iv) instructions for enriching those target genes with the highest z-scores for those most likely to be directly involved in the disease using gene ontology enrichment analysis or pathway database search, wherein the enriching identifies a set of candidate disease-mediator genes; and (v) instructions for outputting the identities of the set of candidate disease-mediator genes to a computer-readable memory or to the user interface.

In another aspect, encompassed herein is a computer-readable medium comprising computer-executable instructions for predicting synergistic drug combinations for treating a given disease, the medium comprising: (a) instructions for receiving a test gene expression data set from a sample derived from an individual or set of individuals treated with a first drug; (b) instructions for filtering the gene expression data set through a reverse engineered gene regulatory network derived for an organism to identify a set of candidate genes influenced by the first drug; (c) instructions for assigning a z-score to each candidate gene in the set of candidate genes, and for ranking the candidate genes according to z-score, wherein increasing z-scores correlate with increasing likelihood of direct influence by treatment with the first drug; (d) instructions for enriching those candidate genes with the highest z-scores using gene ontology enrichment analysis or pathway database search, wherein the enriching provides an enriched set of candidate drug-influenced genes, and wherein the enriched set of candidate drug-influenced genes represents potential therapy targets that are predicted to have a combined efficacy for treating a given disease that is greater than the added efficacy of each agent alone; and (e) instructions for outputting the identities of the set of candidate drug-influenced genes to a computer-readable memory or to an output device.

In another aspect, encompassed herein is a computer system for predicting synergistic drug combinations for treating a given disease, the system comprising: (a) a user interface; (b) a computer processor capable of executing computer executable instructions encoded on a computer-readable medium; (c) a computer readable medium comprising: (i) instructions for receiving a test gene expression data set from a sample derived from an individual or set of individuals treated with a first drug; (ii) instructions for filtering the gene expression data set through a reverse engineered gene regulatory network derived for an organism to identify a set of candidate genes influenced by the first drug; (iii) instructions for assigning a z-score to each candidate gene in the set of candidate genes, and for ranking the candidate genes according to z-score, wherein increasing z-scores correlate with increasing likelihood of direct influence by treatment with the first drug; (iv) instructions for enriching those candidate genes with the highest z-scores using gene ontology enrichment analysis or pathway database search, wherein the enriching provides an enriched set of candidate drug-influenced genes, and wherein the enriched set of candidate drug-influenced genes represents potential therapy targets that are predicted to have a combined efficacy for treating a given disease that is greater than the added efficacy of each agent alone; and (v) instructions for outputting the identities of the set of candidate drug-influenced genes to a computer-readable memory or to an output device.

In another aspect, encompassed herein is a computer-readable medium comprising computer-executable instructions for identifying targets for enhancing the efficacy of a drug used to treat a given disease, the medium comprising: (a) instructions for receiving a test gene expression data set obtained from a sample derived from a subject or set of subjects treated with a first drug; (b) instructions for filtering a test gene expression data set from a sample derived from a subject or set of subjects treated with a first drug through a reverse engineered gene regulatory network derived for an organism to identify a set of candidate genes that are modulated in the subject of set of subjects following treatment with the first drug; (b) instructions for assigning a z-score to each gene in the set of candidate genes, and for ranking the candidate genes according to z-score, wherein increasing z-scores correlate with increasing likelihood of direct influence by the first drug; (c) instructions for enriching those candidate genes with the highest z-scores using gene ontology enrichment analysis or pathway database search, wherein the enriching provides an enriched set of candidate drug-influenced genes representing genes predicted to be involved in an individual's response to the first drug; and (d) instructions for outputting the identities of the enriched set of candidate drug-influenced genes to a computer-readable memory or to a user interface, wherein the enriched set of candidate drug influenced genes represents a set of candidate targets for enhancing the efficacy of the first drug.

In another aspect, encompassed herein is a computer system for identifying targets for enhancing the efficacy of a drug used to treat a given disease, the system comprising: (a) a user interface; (b) a computer processor capable of executing computer executable instructions encoded on a computer-readable medium; (c) a computer readable medium comprising: (i) instructions for receiving a test gene expression data set obtained from a sample derived from a subject or set of subjects treated with a first drug; (ii) instructions for filtering the test gene expression data set from a sample derived from a subject or set of subjects treated with a first drug through a reverse engineered gene regulatory network derived for an organism to identify a set of candidate genes that are modulated in the subject of set of subjects following treatment with the first drug, (iii) instructions for assigning a z-score to each gene in the set of candidate genes, and for ranking the candidate genes according to z-score, wherein increasing z-scores correlate with increasing likelihood of direct influence by the first drug; (iv) instructions for enriching those candidate genes with the highest z-scores using gene ontology enrichment analysis or pathway database search, wherein the enriching provides an enriched set of candidate drug-influenced genes representing genes predicted to be involved in an individual's response to the first drug; and (v) instructions for outputting the identities of the enriched set of candidate drug-influenced genes to a computer-readable memory or to a user interface, wherein the enriched set of candidate drug influenced genes represents a set of candidate targets for enhancing the efficacy of the first drug.

In another aspect, encompassed herein is a computer-readable medium comprising instructions for identifying targets for tailoring a drug therapy to an individual, the medium comprising: (a) instructions for receiving a gene expression data set from a sample derived from an individual treated with a first drug; (b) instructions for filtering the gene expression data set through a reverse engineered gene regulatory network derived for an organism, to identify a set of candidate gene targets that are upregulated in the individual; (c) instructions for assigning a z-score to each target gene in the set of candidate gene targets, and for ranking the target genes according to z-score; (d) instructions for enriching the target genes with highest z-score using gene ontology enrichment analysis or pathway database search, wherein the enriching provides an enriched set of candidate drug-influenced genes representing genes predicted to be involved in an individual's response to the first drug; and (e) instructions for outputting the enriched set of candidate drug-influenced genes to a memory or to a user interface, wherein the set represents targets for tailoring the individual's response to the first drug.

In another aspect, encompassed herein is a computer system for identifying targets for tailoring a drug therapy to an individual, the system comprising: (a) a user interface; (b) a computer processor capable of executing computer executable instructions encoded on a computer-readable medium; (c) a computer readable medium comprising: (i) instructions for receiving a gene expression data set from a sample derived from an individual treated with a first drug; (ii) instructions for filtering the gene expression data set through a reverse engineered gene regulatory network derived for an organism, to identify a set of candidate gene targets that are upregulated in the individual; (iii) instructions for assigning a z-score to each target gene in the set of candidate gene targets, and for ranking the target genes according to z-score; (iv) instructions for enriching the target genes with highest z-score using gene ontology enrichment analysis or pathway database search, wherein the enriching provides an enriched set of candidate drug-influenced genes representing genes predicted to be involved in an individual's response to the first drug; and (v) instructions for outputting the enriched set of candidate drug-influenced genes to a memory or to the user interface, wherein the set represents targets for tailoring the individual's response to the first drug.

### DEFINITIONS

As used herein, the term “reverse engineered gene regulatory network” refers to a network model of gene regulatory interactions in a cell, tissue or organism derived using a training data set of whole-genome expression profiles. Broadly, a “biological network” comprises a group of biochemical species in which individual species may influence or affect the activity of other biochemical species within the network. A “reverse-engineered gene regulatory network” model is generally constructed using measurements of inputs to and outputs from the network, and is thus referred to as a “reverse-engineered” network model. In a preferred embodiment, a reverse-engineered gene regulatory network comprises a set of differential equations or difference equations in which the activities of the individual elements of the network, i.e., the biochemical species, are represented by variables. The equations express the regulatory relationships between the different biochemical species. The term “reconstructed gene regulatory network” is equivalent to the term “reverse-engineered gene regulatory network” as it is used herein.

As used herein, the term “derived for an organism” means that a gene regulatory network representing gene regulatory interactions operating in an organism has been inferred or determined through analysis of a number of gene expression profiles representing a plurality, and preferably a large plurality (e.g., 50 or more, 75 or more, 100 or more, 150 or more, 200 or more, etc.), of different states or perturbed states of a cell, tissue or organism.

As used herein, the term “test gene expression data set” refers to a set of gene expression data, also referred to as an “expression profile” for a given status or condition of interest for a cell, tissue or organism. For example, the genes or proteins expressed in a cell, tissue or organism treated with a drug, or in an organism suffering from a disease of interest, will be represented by a test gene expression data set. A test gene expression data set is tested against or filtered through a reverse-engineered gene regulatory network to identify predicted mediators of the status or condition of interest.

As used herein, the term “filtering a test gene expression data set” refers to a process of inputting test gene expression profile data to a reverse-engineered network model or applying test profile data to such a network. Such “filtering” produces a set of predicted mediators of a given response or status represented by the test gene expression data set.

As used herein, the term “enriching target genes” refers to a process of selecting, from a set of predicted mediators or candidate target genes for a given response or status of interest represented by a test gene expression data set, a subset of genes or mediators with an increased likelihood of more proximal or direct involvement in the response or status of interest. Such enrichment is preferably performed using gene ontology enrichment analysis or searching against one or more pathway databases.

As used herein, the term “target genes with the highest z-scores” refers to a user-selected limit of the number of candidate target genes selected for enrichment as that term is used herein. The number of target genes with the highest z scores can vary, for example, with the number of candidate target genes identified and with the desired sensitivity of the analysis. Selecting a greater number of highest z-scored genes for enrichment will result in a more inclusive, but less sensitive set of candidate mediator genes for a given response or status. Selecting a lower number of highest z-scored genes for enrichment will result in a less inclusive, but likely higher relevance set of candidate mediator genes. The number of target genes with the highest z scores selected for enrichment in the methods described herein will generally be the 50 to 500 genes with the highest z-scores, preferably the top 100 to 300 highest z-scored genes.

As used herein, the term “gene ontology enrichment analysis” refers to a process that selects, from a set of candidate target genes, a subset that are most likely to participate in a given status or response to a perturbation, based on functional enrichment analysis using those target genes with the highest z-scores and an annotated gene ontology (GO) database. GO enrichment analysis can be performed using a number of different software packages known to those of skill in the art. Numerous examples of GO software and web-based analysis platforms are provided on the Gene Ontology Consortium's website (geneontology.org/GO.tools.microarray.shtml; see Nucleic Acids Res. 2004, 32: d258-261, “Gene Ontology Consortium: The Gene Ontology (GO) database and informatics resource”), and include, as non-limiting examples: EasyGO (available on the internet at bioinformatics.cau.edu.cn/easygo/); Avadis (Strand Genomics, Bangalore, India); Database for Annotation, Visualization and Integrated Discovery (DAVID), National Institute for Allergy and Infectious Disease (see Dennis et al., 2003, Genome Biol. 4: P3); eGOn v2.0, Norwegian University for Science and Technology and Norwegian Microarray Consortium; ermineJ, Lee et al., 2005, BMC Bioinformatics 6: 269; FatiGO, Al-Sharous et al., 2004, Bioinformatics 20: 5780580; FunCluster, Henegar et al., J. Bioinform. Comput. Biol. 4: 833-852, Taleb et al., 2006, Eur. J. Clin. Invest. 36: 153-163; GARBAN, Martinez-Cruz et al., 2003, Bioinfirmatics 19: 2158-2160; GOALIE, New York University Bioinformatics Group; GO Array, Yale Center for Medical Informatics; GOdist, Ben-Shaul et al., 2005, Bioinformatics 21: 1129-1137; GOHyperGAll, University of California at Riverside; L2L, Newman et al., 2005, Genome Biol. 6: R81; Ontology Traverser, Young et al., 2005, Bioinformatics 21: 275-276; and ProfCom, Antonov et al., 2006, J. Mol. Biol. 363: 289-296.

As used herein, the term “pathway database search” refers to enrichment analysis using a pathway annotation/analysis database, such as KEGG, Ingenuity Pathway™, or others like them. Pathway database searching can permit the identification of candidate pathways and members of them that are differentially active in a cell, tissue or organism under a given set of conditions based on patterns of genes or proteins expressed in a sample or set of samples.

As used herein, a “compendium of gene expression data sets” is a collection of a large number of gene expression data sets, each representing a different status or perturbation of a gene expression system. A compendium of gene expression data sets is used as a training set to develop a reverse-engineered gene regulatory network. The “large number” can vary, with higher numbers providing progressively more sensitive network models for predictions of target genes. At a minimum, a “large number” will be at least 50 different gene expression data sets, but preferably higher, e.g., at least 70, at least 90, at least 100, at least 120, at least 130, at least 150, at least 170, at least 190, at least 200, at least 220, at least 240, at least 260, at least 280, at least 300, at least 320, at least 340, at least 360, at least 380, at least 400, at least 420, at least 440, at least 460, at least 480, at least 500, at least 520, at least 540, at least 560, at least 580, at least 600 or more. It is also preferred, although not absolutely required, that each of the expression profiles of gene expression data sets in a compendium is generated from the same platform. For example, where a microarray platform is used, it is preferable that all microarray data are generated using the same microarray platform, to minimize variations due to differences in the platforms themselves.

As used herein, the phrase “targeting a candidate disease-mediator gene for modulation with an agent” or “targeting a candidate drug efficacy mediator gene for modulation with an agent” refers to the selection of one member of a list of candidate disease mediator genes identified according to the methods described herein for artificial modulation or therapeutic intervention. As a general consideration, genes or gene products that are overexpressed in a disease phenotype are opportune targets because it is often easier to target a gene or gene product for inhibition (e.g., with RNAi, an antibody or antibody fragment, or a small molecule inhibitor) than it is to increase expression of an underexpressed gene or to stimulate the activity of a protein product. That said, it is specifically contemplated herein that a candidate gene can be targeted to increase its expression or the activity of its product in some instances. Gene therapy can be effective to express a therapeutic gene product in a host temporarily or for longer term, and is becoming steadily more effective.

In some instances, the selected gene or its gene product is selected because one or more effective, safe modulators, e.g. a small molecule drug, is known in the art. In other instances, the selected gene or its gene product is selected over other possible candidates because it is in a separate pathway from that targeted by other agents; the modulation of different pathways involved in a given process can have different effects, and, when an agent that modulates one pathway is administered with an agent that modulates a different pathway involved in the same phenomenon, there can be additive or even synergistic effects. While it can be advantageous to select members of two or more different pathways identified as involved in a given phenomenon or disease, it can also be advantageous to target two or more members of the same pathway; targeting two members of the same pathway can more effectively modulate that pathway in some instances relative to targeting only a single member of the pathway.

To target a disease phenotype or other phenomenon with one agent or a combination of agents, one of the considerations can be how closely in the pathway each agent acts to the gene or gene product that ultimately causes the effect one wishes to modulate. Where one wishes to shut down the production of a gene product that is inappropriately overexpressed, it can be helpful to target that gene or its product directly, as opposed to targeting a gene product earlier in a signal transduction pathway leading to expression of that gene. It may be more efficient to target the end gene products directly, and it may avoid side effects relative to the situation in which one targets a gene upstream in the pathway, because the upstream gene or its product may well be involved in other processes that are important to the health of the individual.

As used herein, the phrase “inhibition of a gene” or variations on the phrase relating to specific genes, refers to the inhibition of the expression of a gene, and can also refer to the inhibition of the activity of the gene product. Thus, for example, the “inhibition of a gene” can refer to inhibition mediated by an RNAi molecule targeting the gene's transcript for degradation, or the “inhibition of a gene” can refer to the inhibition of the activity of the gene product with an antibody or antigen binding fragment thereof that binds and inhibits the activity of the translation product of the gene. In general, a gene is “inhibited” if there is at least 20% less, at least 30% less, at least 40% less, at least 50% less, at least 60% less, at least 70% less, at least 80% less, at least 90% less or even 100% less (i.e., absent) of its transcription or translation product following treatment with an inhibitor or inhibitors.

An “RNA interference molecule” as used herein, is defined as any agent which interferes with or inhibits expression of a target gene or genomic sequence by RNA interference (RNAi). Such RNA interfering agents include, but are not limited to, nucleic acid molecules including RNA molecules which are homologous to a target gene or genomic sequence, or a fragment thereof, short interfering RNA (siRNA), short hairpin or small hairpin RNA (shRNA), microRNA (miRNA) and small molecules which interfere with or inhibit expression of a target gene by RNA interference (RNAi).

“RNA interference (RNAi)” is an evolutionally conserved process whereby the expression or introduction of RNA of a sequence that is identical or highly similar to a target gene results in the sequence specific degradation or specific post-transcriptional gene silencing (PTGS) of messenger RNA (mRNA) transcribed from that targeted gene45, thereby inhibiting expression of the target gene. In one embodiment, the RNA is double stranded RNA (dsRNA). This process has been described in plants, invertebrates, and mammalian cells. In nature, RNAi is initiated by the dsRNA-specific endonuclease Dicer, which promotes processive cleavage of long dsRNA into double-stranded fragments termed siRNAs. siRNAs are incorporated into a protein complex (termed “RNA induced silencing complex,” or “RISC”) that recognizes and cleaves target mRNAs. RNAi can also be initiated by introducing nucleic acid molecules, e.g., synthetic siRNAs or RNA interfering agents, to inhibit or silence the expression of target genes. As used herein, “inhibition of target gene expression” includes any decrease in expression or protein activity or level of the target gene or protein encoded by the target gene as compared to a situation wherein no RNA interference has been induced. The decrease will be of at least 10%, at least 20%, at least 30%, at least 40%, at least 50%, at least 60%, at least 70%, at least 80%, at least 90%, at least 95% or at least 99% or more as compared to the expression of a target gene or the activity or level of the protein encoded by a target gene which has not been targeted by an RNA interference molecule. The terms “RNA interference” and “RNA interference molecule” as they are used herein are intended to encompass those forms of gene silencing mediated by double-stranded RNA, regardless of whether the RNA interfering agent comprises an siRNA, miRNA, shRNA or other double-stranded RNA molecule.

“Short interfering RNA” (siRNA), also referred to herein as “small interfering RNA” is defined as an RNA agent which functions to inhibit expression of a target gene, e.g., by RNAi. An siRNA may be chemically synthesized, may be produced by in vitro transcription, or may be produced within a host cell. In one embodiment, siRNA is a double stranded RNA (dsRNA) molecule of about 15 to about 40 nucleotides in length, preferably about 15 to about 28 nucleotides, more preferably about 19 to about 25 nucleotides in length, and more preferably about 19, 20, 21, 22, or 23 nucleotides in length, and may contain a 3′ and/or 5′ overhang on each strand having a length of about 0, 1, 2, 3, 4, or 5 nucleotides. The length of the overhang is independent between the two strands, i.e., the length of the overhang on one strand is not dependent on the length of the overhang on the second strand. Preferably the siRNA is capable of promoting RNA interference through degradation or specific post-transcriptional gene silencing (PTGS) of the target messenger RNA (mRNA).

As used herein, the term “small molecule” refers to a chemical agent including, but not limited to, peptides, peptidomimetics, amino acids, amino acid analogs, polynucleotides, polynucleotide analogs, aptamers, nucleotides, nucleotide analogs, organic or inorganic compounds (i.e., including heteroorganic and organometallic compounds) having a molecular weight less than about 10,000 grams per mole, organic or inorganic compounds having a molecular weight less than about 5,000 grams per mole, organic or inorganic compounds having a molecular weight less than about 1,000 grams per mole, organic or inorganic compounds having a molecular weight less than about 500 grams per mole, and salts, esters, and other pharmaceutically acceptable forms of such compounds.

As used herein, the term “synergistic drug combinations” is used to describe an effect of two or more agents that when used together is significantly greater than expected from each agent's effect when used individually. In addition, the term “synergistic drug combinations” encompasses an effect of two or more agents when used together that is significantly greater than expected from their effects when used in combination (e.g., synergism encompasses a larger response than an “additive effect”). By “additive effect” is meant that the effects of two or more agents sum to an added effect that is less than or equal to the expected added effect of each agent alone. Using additive drug combinations for treating a subject is specifically contemplated herein. A drug combination is considered “synergistic” when the combined effect is at least 10% greater than the added effect of either agent alone, preferably at least 20% greater, at least 30% greater, at least 40% greater, at least 50% greater, at least 60% greater, at least 70% greater, at least 80% greater, at least 90% greater, at least 95% greater, at least 99% greater, at least 1-fold greater, at least 10-fold greater, at least 50-fold greater, at least 100-fold greater, at least 1000-fold greater or more, than the added effect of each agent alone.

As used herein, the term “modulates a gene or product thereof” is used to describe an increase or decrease in the activity, protein level, or RNA level of the gene or gene product thereof. By “increase” is meant an increase in gene or gene product expression of at least 10% higher, at least 20% higher, at least 30% higher, at least 40% higher, at least 50% higher, at least 60% higher, at least 70% higher, at least 80% higher, at least 90% higher, at least 95% higher, at least 99% higher, at least 1-fold higher, at least 5-fold higher, at least 10-fold higher, at least 50-fold higher, at least 100-fold higher, at least 1000-fold or more higher following treatment with an agent than the gene or gene product expression prior to treatment with an agent. By “decrease” is meant a decrease in gene or gene product expression of at least 10%, at least 20%, at least 30%, at least 40%, at least 50%, at least 60%, at least 70%, at least 80%, at least 90%, at least 95%, at least 99%, or even 100% (e.g., absent) lower following treatment with an agent than the gene or gene product expression prior to treatment with an agent.

As used herein, the term “enhances the efficacy of said first drug” refers to an increase in the efficacy of the first drug of at least 10% higher than the efficacy of the first drug without a change in the dose of the first drug. Preferably, the increase in efficacy is at least 20% higher, at least 30% higher, at least 40% higher, at least 50% higher, at least 60% higher, at least 70% higher, at least 80% higher, at least 90% higher, at least 95% higher, at least 99% higher, at least 1-fold higher, at least 5-fold higher, at least 10-fold higher, at least 50-fold higher, at least 100-fold higher, at least 1000-fold or more higher than the efficacy of the first drug when used at the same dose.

As used herein the term “increasing the in vivo half-life of said first drug” refers to an increase in the in vivo half-life of the first drug by at least 10% greater than the half-life of the drug when used alone. Preferably at least 20% greater, at least 30% greater, at least 40% greater, at least 50% greater, at least 60% greater, at least 70% greater, at least 80% greater, at least 90% greater, at least 95% greater, at least 99% greater, at least 1-fold greater, at least 10-fold greater, at least 50-fold greater, at least 100-fold greater, at least 1000-fold greater or more, than the half-life of the first drug when used alone.

As used herein, the term “slowing metabolism of said first drug” refers to a decrease in the rate of degradation of the first drug of at least 10% lower than when the first drug is used alone. Preferably, the degradation of the first drug is at least 20% lower, at least 30% lower, at least 40% lower, at least 50% lower, at least 60% lower, at least 70% lower, at least 80% lower, at least 90% lower, at least 95% lower, or at least 99% lower than the degradation of the first drug when used alone.

As used herein, the term “decreasing clearance of said first drug” refers to a decrease in the rate of excretion of the drug and/or active metabolites of the drug of at least 10% slower than when the first drug is used alone. Preferably, the rate of excretion of the first drug is at least 20% slower, at least 30% slower, at least 40% slower, at least 50% slower, at least 60% slower, at least 70% slower, at least 80% slower, at least 90% slower, at least 95% slower, or at least 99% slower than the rate of excretion of the first drug when used alone.

As used herein, the term “decreasing a side effect of said first drug” refers to a decrease in the incidence or severity of a side effect in a population treated with a particular dose of the first drug of at least 1%, at least 2%, at least 5%, at least 10%, at least 20%, at least 30%, at least 40%, at least 50%, at least 60%, at least 70%, at least 80%, at least 90%, at least 95%, at least 99%, or even a 100% (e.g., absent) decrease in the incidence or severity of a side effect in a population treated with a particular dose of the first drug.

As used herein, the term “increasing bioavailability of said first drug” refers to an increase in absorption or an increase in tissue accumulation of the first drug of at least 10% greater than when the first drug is used alone. Preferably, at least 20% greater, at least 30% greater, at least 40% greater, at least 50% greater, at least 60% greater, at least 70% greater, at least 80% greater, at least 90% greater, at least 95% greater, at least 99% greater, at least 1-fold greater, at least 10-fold greater, at least 50-fold greater, at least 100-fold greater, at least 1000-fold greater or higher, increase in absorption and/or tissue accumulation of the first drug when used alone.

As used herein, the term “enhances the response of said individual to said first drug” is used to describe an increase in the effectiveness of a drug in the treatment of a disease of at least 10% greater than the effect of the first drug when used alone. Preferably the effectiveness is at least 20% greater, at least 30% greater, at least 40% greater, at least 50% greater, at least 60% greater, at least 70% greater, at least 80% greater, at least 90% greater, at least 95% greater, at least 99% greater, at least 1-fold greater, at least 10-fold greater, at least 50-fold greater, at least 100-fold greater, at least 1000-fold or more greater, than the effectiveness of the first drug when used alone. The effectiveness of a drug can be assessed by measuring the level of a measurable symptom or a change in a disease-specific marker. For example, the effectiveness of a cholesterol-lowering drug can be determined by measuring circulating lipoproteins in a blood sample from a subject.

As used herein, the term “tailoring a drug therapy to an individual” is used to describe a method for treating a subject based on the subject's specific needs. Thus, the network biology approach disclosed herein can be used to identify candidate disease-mediator genes that are differentially altered from the mean expression level of a population. A candidate disease-mediator gene is differentially altered if the expression is at least 5% higher or lower than the mean expression level of a population (e.g., the reverse engineered gene regulatory network derived for an organism). Preferably the candidate disease mediator gene is at least 10% higher, at least 20% higher, at least 30% higher, at least 40% higher, at least 50% higher, at least 60% higher, at least 70% higher, at least 80% higher, at least 90% higher, at least 95% higher, at least 1-fold higher, at least 5-fold higher, at least 10-fold higher, at least 50-fold higher, at least 100-fold higher, at least 1000-fold or more higher than the expression level of the reverse engineered gene regulatory network. Alternatively, the candidate disease-mediator gene is at least 10% lower, at least 20% lower, at least 30% lower, at least 40% lower, at least 50% lower at least 60% lower, at least 70% lower, at least 80% lower, at least 90% lower, at least 95% lower, at least 99% lower or 100% lower (e.g., absent). Following the identification of a set of candidate genes in an individual, a candidate disease-mediator gene is selected for treatment with an agent or plurality of agents, such that the treatment is designed to modulate gene or gene product expression in the individual that is specific to the individual's gene expression profile.

As used herein the term “comprising” or “comprises” is used in reference to compositions, methods, and respective component(s) thereof, that are essential to the invention, yet open to the inclusion of unspecified elements, whether essential or not.

As used herein the term “consisting essentially of” refers to those elements required for a given embodiment. The term permits the presence of elements that do not materially affect the basic and novel or functional characteristic(s) of that embodiment of the invention.

The term “consisting of” refers to compositions, methods, and respective components thereof as described herein, which are exclusive of any element not recited in that description of the embodiment.

As used in this specification and the appended claims, the singular forms “a,” “an,” and “the” include plural references unless the context clearly dictates otherwise. Thus for example, references to “the method” includes one or more methods, and/or steps of the type described herein and/or which will become apparent to those persons skilled in the art upon reading this disclosure and so forth.

### BRIEF DESCRIPTION OF THE FIGURES

FIG. 1 is a flow diagram illustrating a process for identifying multiple therapeutic targets.

FIG. 2 is a schematic representation of using MNI for therapeutic target identification. A compendium of microarray gene expression datasets relevant to a phenotype (e.g., a type of disease) is collected in house or from public data to reverse engineer the regulatory network. The therapeutic targets are identified by evaluating the inconsistency of the genes with the background network reconstructed from the compendium using the testing samples.

FIG. 3 is a block diagram of an exemplary computer system.

FIG. 4 illustrates symbols and notations used by Ingenuity pathway analysis. The pathways shown in FIG. 5-7 use the symbols and notations shown in this Figure.

FIG. 5 illustrates one example of Ingenuity pathway analysis of MNI-predicted drug-resistance mediators. Cell death related pathway #3: Cell Death, Neurological Disease, Molecular Transport, was enriched with a p-value less than 10e-13. The exemplary gene, Bcl-2, is known to be involved in drug resistance due to a role in decreasing apoptosis. Exemplary genes, MPO and GCLC, were found to be connected to Bcl-2 in the network and thus serve as potential candidates for vincristine (VCR) resistance.

FIG. 6 shows one example of Ingenuity pathway analysis of MNI-predicted disease mediators. Cancer related pathway #4: Cancer, Gene Expression, Cell Morphology, was enriched with p-value less than 10e-12. Genes such as, for example the tumor suppressor gene APC that are known to be highly involved in cancer development were identified. Genes that connect to the known tumor suppressor gene TP53 could serve as a good candidate for further screen. For example, HUWE1 inactivates TP53 and its expression is upregulated in HCC samples, thus it could potentially be silenced with RNAi as a part of HCC therapy.

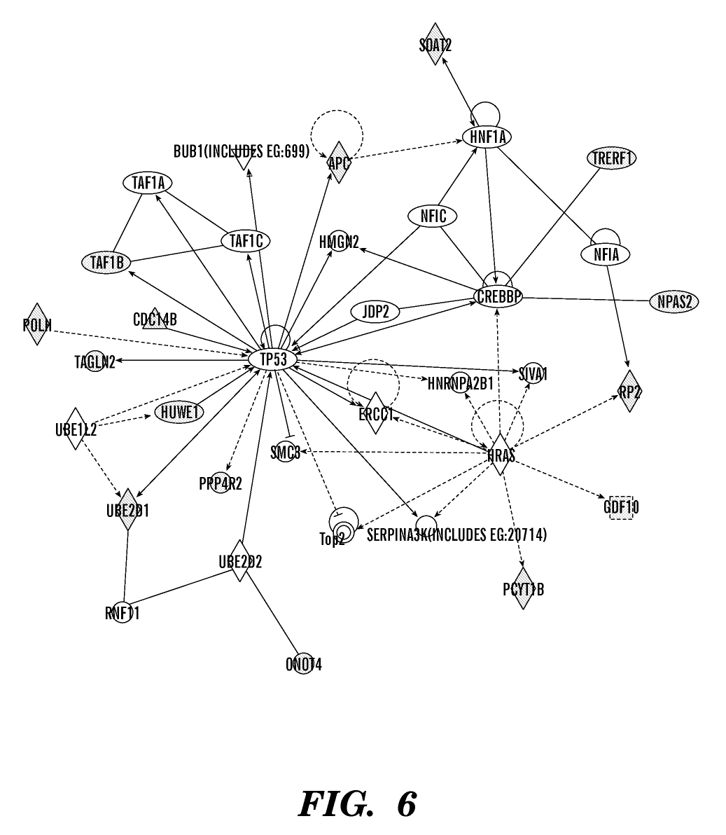

FIG. 7 illustrates identification of exemplary RNAi combination therapy candidates through pathway analysis: an enriched network of cellular cell cycle and cell survival. Based on the pathway analysis, genes are found that connect to the exemplary cell cycle regulator gene Rb1 and cell survival pathway component gene Akt. For example, SMARCA2 (206543_at, #78 ranked by MNI) is functionally related to Rb1; loss of core SWI-SNF subunits of SMARCA2 renders cancer cells resistant to activation of the RB pathway by the chemotherapeutic agent cisplatin [21]. THPO (21115_s_at, #4 ranked by MNI) connects to Akt, with THPO activating Akt. The expression of these two genes are both upregulated in HepG2 cells, thus they serve as potential candidates for RNAi combination therapy.

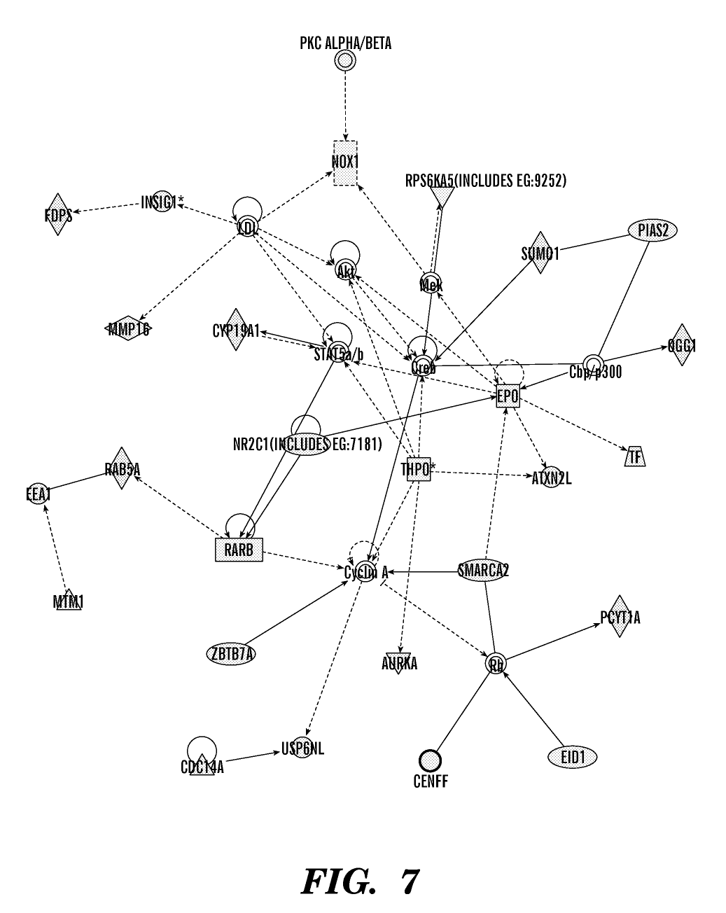

### DETAILED DESCRIPTION

Described herein is a network biology approach useful for the identification of multiple therapeutic targets, which can be targeted simultaneously using an agent (or a plurality of agents) to modulate cellular phenotypes, or in combination with pharmaceutical compounds to improve the drug sensitivity and/or reduce the drug doses for minimal side effects. The approach disclosed herein relies on first identifying the mediators of a condition of interest, and second, selecting gene combinations that are in competing/parallel pathways.

In general, the methods described herein are based on an applied network biology approach, namely, mode-of-action by network identification (MNI) [3, 4], to reverse engineer a gene regulatory network from a compendium of microrray gene expression profiles. This reverse engineered network is used as a filter to identify mediators of a disease. Enrichment analysis is then performed on the top ranked mediator genes to identify enriched pathways that aid in the design of the combination therapy.

The following describes methods and considerations involved in practicing the methods and systems disclosed herein.

### Biological Networks

For the various aspects of the methods described herein, a biological network comprises a group of biochemical species in which individual biochemical species can influence or affect the activity of other biochemical species within the network. A biological network can include biochemical species of only a single type or can include biochemical species of multiple different types. For example, a network can include genes but not RNA molecules, proteins, metabolites, or other molecules. Alternately, a network can include a combination of different types of biochemical species, e.g., genes and proteins. Where the biological system is a cell population, tissue, organ, or multicellular organism, the biochemical species can be individual cells (in the case of a cell population or tissue), individual cells or tissues (in the case of an organ), or individual cells, tissues, or organs (in the case of a multicellular organism), in addition to any of the biochemical species mentioned above. It will be appreciated that when the biological system is a cell, measurements of activities typically involve populations of cells. Nevertheless, the model can be considered to represent a biological network as present in a single cell.

A biological network can be defined to include any number of biochemical species, provided it is possible to measure their activity and, preferably, feasible to perturb it (although it is not a requirement that all species in a network be perturbed or perturbable). Thus the species included in the network can be selected in any manner desired by the experimenter. The methods described herein identify interactions between any arbitrarily (or otherwise) chosen set of biochemical species, and construct a model of a biological network comprising the species. Networks described herein are preferably derived in a computer-assisted manner.

In general, each biochemical species included in a network will have one or more associated properties or features, referred to as “activities”. In the case of genes, the activity typically represents the level of expression of the gene (e.g., whether or not it is transcribed (“on/off”) or, preferably, a quantitative amount of expression), which can be measured in terms of RNA or protein level. By “expression level of a gene” is meant the abundance of either RNA transcribed using that gene as a template or the abundance of protein encoded by that gene. By “expression level” of species other than a gene is meant the abundance of that species in the biological system. In the case of RNA molecules, proteins, metabolites, or other molecules the activity can represent the expression level or abundance of the biochemical species within the biological system. In general, an expression level or abundance of a species can be expressed in terms of absolute or relative abundance, absolute or relative concentration, or using any other appropriate means. Alternately, the activity can represent a property such as ability to catalyze a biochemical reaction (enzymatic activity), etc.

Many of the cellular constituents mentioned above can exist in a variety of different forms or states. For example, genes can be methylated or unmethylated. RNA molecules can be spliced, polyadenylated, or otherwise processed. Proteins can be phosphorylated, glycosylated, cleaved, etc. In addition, cellular constituents can associate with other cellular constituents and/or be present in complexes with other constituents. Each of these different forms or states of any individual cellular constituent can be considered a biochemical species as can complexes comprising multiple cellular constituents. For example, a methylated form of an enzyme can be considered a first biochemical species with an activity that represents the concentration of the methylated form, while the unmethylated form of the same enzyme can be considered a second species with an activity that represents its catalytic rate. Alternately, one or more different forms or states of a cellular constituent can be considered to be a single biochemical species, with each form or state having a different activity. For example, a phosphorylated protein can be assigned an activity of 1, while the unphosphorylated form can be assigned an activity of 0. A number between 0 and 1 then reflects the degree of phosphorylation of the protein, considered as a single biochemical species, within the biological system.

It will be evident that any particular biochemical species can have multiple activities that can be significant in terms of the interaction of the biochemical species with other biochemical species in the network. For example, a protein can have both an expression level and a phosphorylation state.

In the physical world, a biological network comprises actual genes, RNA molecules, proteins, metabolites, and other molecules. These elements can interact (e.g., physically interact) so as to influence or regulate each other's activity. For example, a transcription factor can bind to a promoter located upstream of a coding sequence in a gene, which ultimately leads to increased transcription of an mRNA for which the gene provides a template. A protein kinase can transfer a phosphate group to a substrate protein, which can increase or decrease the enzymatic activity of the substrate.

The methods described herein are applicable to cells of any type, including prokaryotic, e.g., bacterial, and eukaryotic, e.g., yeast and other fungi, insect, and mammalian, including human. The methods can be applied to either wild type or mutant cells, cells obtained from an individual suffering from a condition such as a particular disease, cells that have become resistant to therapy, cells that have been genetically altered, etc. As described below, the models of biological networks have a number of applications. For example, the models can be used to identify regulators of particular biological species, major regulators of the network, and biochemical targets of compounds and environmental changes.

### MNI Algorithm

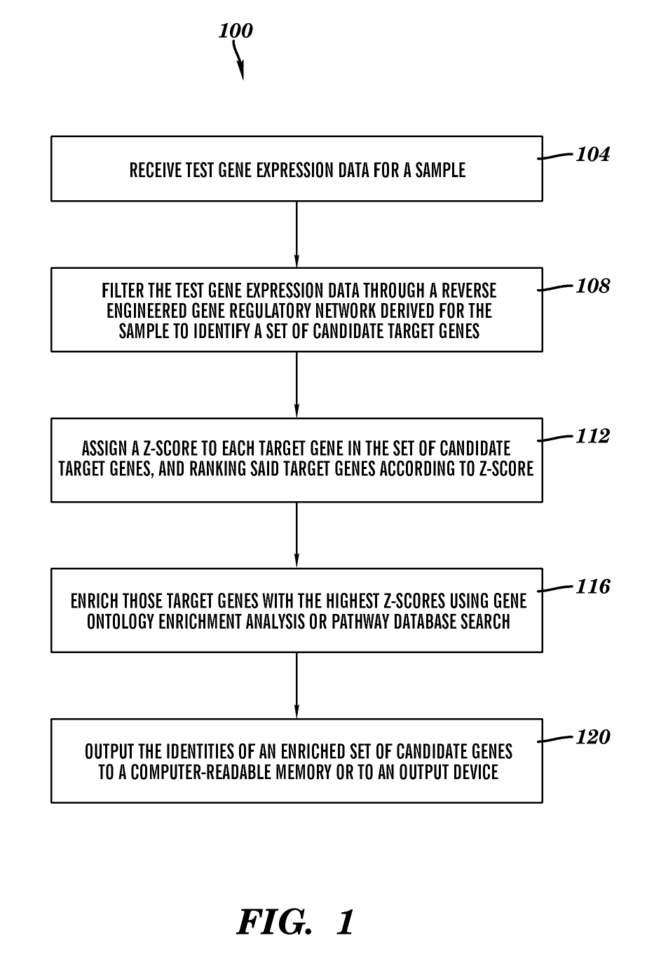

FIG. 1 illustrates a process 100 for identifying therapeutic target genes using the MNI algorithm. It will be appreciated that the process 100 described below is merely exemplary and may include a fewer or greater number of steps, and that the order of at least some of the steps may vary from that described below.

The process 100 begins, optionally, by receiving test gene expression data for a sample (block 104). The process 100 continues by filtering the test gene expression data through a reverse engineered gene regulatory network derived for the sample to identify a set of candidate target genes (block 108). The process 100 continues by assigning a z-score to each target gene in the set of candidate target genes, and ranking said target genes according to z-score (block 112). The process 100 continues by enriching those target genes with the highest z-scores using gene ontology enrichment analysis or pathway database search (block 116). The process 100 optionally continues by outputting the identities of an enriched set of candidate genes to a computer-readable memory or to an output device (block 120).

### Identification of Disease Mediators

To identify the therapeutic targets for a disease, MNI was used to first predict the disease mediators for a condition of interest. The MNI algorithm operates in two phases to determine significant genetic mediators of a condition of interest. In phase one (network identification phase), a network is derived from an N×M training set of microarray expression data, consisting of measurements of steady-state expression ratios of N transcripts in M experiments. In phase two (mediator determination phase), the trained regulatory network is used as a filter to determine the genes affected by a test condition. To predict the genetic mediators of a disease, the MNI algorithm first infers a model of regulatory influences in a cell. The model relates changes in gene transcript concentrations to each other, and it is not constrained by any a priori knowledge.

The transcript synthesis rate is modeled as a function of the influence of all other transcript concentrations and external influences on the transcript i as follows:

$${\dot{y}}_{i} = {u}_{i} {\prod }_{j} {y}_{j}^{{n}_{ij}} - {d}_{i} {y}_{i} . \qquad ( 1 )$$

where yᵢ represents the concentration of transcript i, nᵢ represents the influence of transcript j on transcript i, dᵢ represents the degradation rate of transcript i, and uᵢ represents the net external influences on the transcription rate of transcript i.

This model structure can be viewed as a simplification of Hill-type transcription kinetics [5]. The log-linear model (also known as the power law function) was used to approximate the nonlinear relation between the genes. The log-linear model has its roots in biochemistry and has been previously used to approximate the relation between reaction rates and their substrates [6, 7, 8]. The log-linear model has also been applied successfully to model the expression of a gene as a power law function of the expression of the genes that regulate it [9]. The advantage of log-linear models is that they are computationally tractable and robust. Although, mechanism-based nonlinear models can capture more accurate behavior, they require additional parameters and more data to estimate these parameters, and, in turn, higher computational cost. Therefore, the log-linear model was used to approximate the non-linear relations between the genes shown in Eq. 1.

Since concentrations, and not transcription rates of mRNA are known, a simplifying assumption is made that transcript concentrations are measured under steady-state conditions. With this assumption, the model becomes:

$${\dot{y}}_{i} = 0 = {u}_{i} {\prod }_{j} {y}_{j}^{{n}_{ij}} - {d}_{i} {y}_{i} . \qquad ( 2 )$$

The measurements were computed relative to a baseline, and with the assumption that the degradation rate is the same for the baseline-level transcripts, the following transformation is made:

$$\frac{{y}_{i}}{{y}_{ib}} = \frac{{u}_{i}}{{u}_{ib}} {\prod }_{j} {( \frac{{y}_{j}}{{y}_{jb}} )}^{{n}_{ij}} . \qquad ( 3 )$$

By taking the logarithm of both sides of Eq. 3 and by substituting variables and parameters, the model is reduced to a log-linear system of equations:

$${\sum }_{j} {a}_{ij} {x}_{j} = - {p}_{i} , where \\ {a}_{ij} = \{ \begin{matrix}{n}_{ij} , & j \neq i \\ {n}_{ij} - 1 , & j = i\end{matrix} \\ {x}_{j} = {log}_{2} ( \frac{{y}_{j}}{{y}_{jb}} ) , and \\ {p}_{i} = {log}_{2} ( \frac{{u}_{i}}{{u}_{ib}} ) . \qquad ( 4 )$$

The model coefficients aᵢⱼ, which constitute the connectivity matrix A, represent the influence of the concentrations of transcript j on the synthesis rate of transcript i. The variables xⱼ are the log-transformed expression-change ratios of each transcript j, and constitute the columns of the training matrix, X. The variables pᵢ are the net external influences on transcript i and constitute the rows of the matrix P. This external perturbations matrix P is used to determine the transcripts that are most inconsistent with the network, and therefore most likely genetic mediators of a disease.

### Phase I: Network Identification

The first task of the MNI algorithm is to learn the network model coefficients aᵢⱼ. For the algorithm, the training matrix X is known while the connectivity matrix A and the external perturbations matrix P are unknown. To estimate the network model A, with no prior knowledge on P, the MNI algorithm uses a recursive strategy. The algorithm starts by using a naïve model of the regulatory structure. Initially, A is specified to account only for self-degradation: aᵢⱼ=−1 for i=j and aᵢⱼ=0 otherwise. This begins the first iteration, where P is estimated directly from A and X. An external influence is considered significant if it satisfies:

$$\hat{{p}_{il}} \geq θ \cdot {max}_{1 \leq l \leq M} ( \vert \hat{{p}_{il}} \vert ) \qquad ( 5 )$$

where θ is the significance threshold. The value of θ=0.25 was chosen for the study, i.e., an estimate of the external influence on transcript i is considered significant if it is greater than 25% of the maximum absolute value of pᵢₗ in all experiments l=1, . . . , M. To finish the iteration, experiments with insignificant perturbations are removed from the training set, and a new connectivity matrix is determined, using linear regression to solve the following equation for aᵢⱼ:

$${\sum }_{j} {a}_{ij} {x}_{j} = - {p}_{i} . \qquad ( 6 )$$

This begins the second iteration, where pᵢ is re-estimated using the newly calculated aᵢⱼ coefficients. This iterative estimation is repeated five times, or until convergence of the variables.

### Phase II: Determination of Disease Mediators

Once a network has been estimated, transcripts that are significantly perturbed in the test profile can be identified. A test expression profile, X_{jc}, where the index jc represents the expression of transcript j in response to a test condition c for j=1, . . . , N, is tested against the network to determine its external influences using the following equation:

$${\sum }_{j} {\hat{a}}_{ic} {x}_{jc} = - {\hat{p}}_{ic} \qquad ( 7 )$$

where −\hat{p}ᵢₜ represents the estimated external influences on each transcript i. The significance of each perturbation is determined by calculating two z-scores based on the perturbation size and estimation error:

$$\begin{matrix}{z}_{ic} = \frac{{\hat{p}}_{ic}}{{σ}_{ic}} ( normal ) & ( 8.1 ) \\ {z}_{ic}^{m} = {z}_{ic} + {x}_{ic} ( modified ) & ( 8.2 )\end{matrix}$$

The modified z-score is designed to boost the likelihood of including genes with significant changes in the test expression profile. In Eq. 8.1, σ_{ic} the standard deviation of the perturbation value, which is calculated by applying propagation of error to Eq. 6, yielding:

$${σ}_{ic}^{2} = {\sum }_{j} {\sum }_{k} {σ}_{jk}^{i} {x}_{jc} {x}_{kc} + {\sum }_{j} {\hat{a}}_{ij}^{2} var ( {x}_{jc} ) , \qquad ( 9 )$$

where σⱼₖⁱ are the elements of the covariance matrix calculated from âᵢⱼ.

Transcripts are ranked according to the normal and modified z-scores, where those with the highest absolute z-score are determined to be those most significantly contributing to disease mediators in each case. The final list is chosen to be that with the highest mean z-score, between the normal or modified z-score lists.

### Singular Value Decomposition

For a training data set of size N×M, where N>>M, calculating aᵢⱼ in Eq. 7 is an under-determined problem. In order to find a unique solution, a dimensional reduction strategy based on singular value decomposition (SVD) to reduce the size of the training set is used. Using SVD, the training matrix, X, is decomposed as:

X=USV^{T} (10)

where U is an N×M matrix, S is a diagonal matrix of dimension M×M containing the singular values of X, and V is an M×M matrix containing the principal components of the transcript expression profiles in columns. Q principal components based on the largest singular values are chosen (Q<M). The Q profiles serve as the characteristic expression profiles for the N transcripts and describe most of the expression variation in the N transcripts. Using the characteristic profiles, X is approximated as follows:

X≈U_{Q}S_{Q}V^{T} (11)

where U_{Q} is an N×Q matrix and contains only the first Q columns of U, and S_{Q} is a Q×M diagonal matrix of the largest Q singular values. These matrices are used to transform X into the metagene space and back into the N-dimensional transcript space to perform the network identification and genetic mediator determination as explained in Sections 3.1.1 and 3.1.2.

### Identification of Gene Combinations

Based on the ranked list of genetic mediators, a combination therapy is designed by performing enrichment analysis based annotations from GO [10], KEGG [11], Ingenuity Pathway [12], or other pathway annotation databases. The genes in the enriched pathways serve as candidate genes for combination therapy. The hypergeometric test is used to compute enrichment scores based on the top ranked genes. The hypergeometric test uses the hypergeometric distribution to calculate the probability of obtaining x or more genes in the top list of genetic mediators by chance. The p value of observing x or more genes in top mediators list of R genes out of possible K genes in a certain pathway, among N possible genes on a given chip, is computed as:

$$p = 1 - F ( x \vert N , K , R ) = 1 - {\sum }_{i = 0}^{x - 1} \frac{( \begin{matrix}K \\ i\end{matrix} ) ( \begin{matrix}N - K \\ R - i\end{matrix} )}{( \begin{matrix}S \\ R\end{matrix} )} \qquad ( 12 )$$

### Implementation of the Network Biology Approach

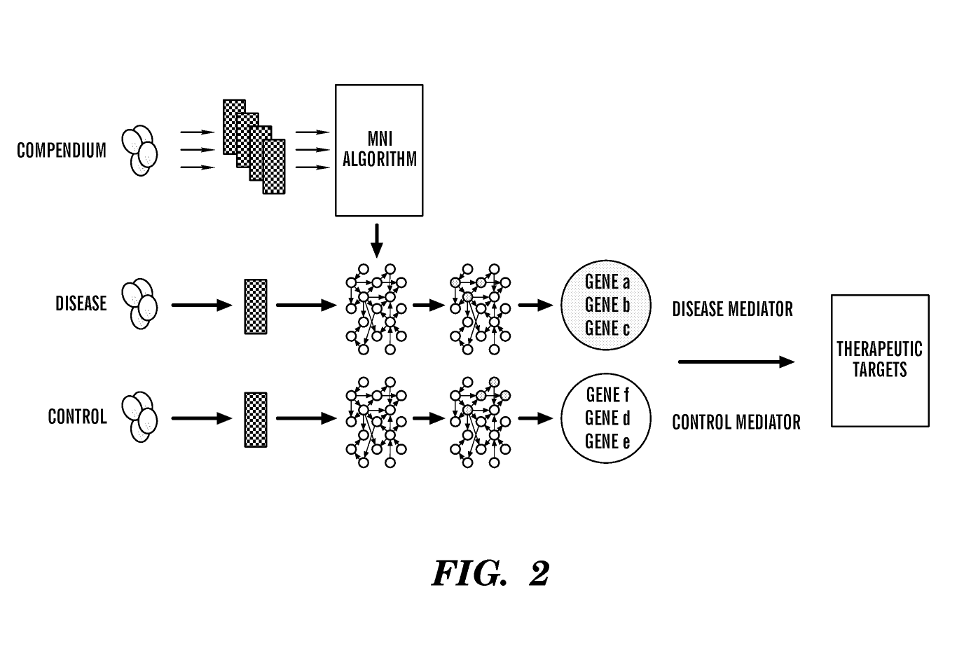

Using MNI to identify therapeutic targets includes the following steps [13]. The process is summarized in FIG. 2 and detailed below:

(1) Preparing training compendium dataset. The training compendium includes the microarray gene expression measurements from experiments of interest, e.g., a specific type of disease(s), a specific tissue or cell type, or a specific phenotype. The data can be collected in house or obtained from a public database, e.g., GEO [14] and ArrayExpress [15]. A highly diverse training dataset with experiments from different environmental conditions, drug treatments and gene perturbations is recommended. A number of M/10 microarrays is recommended, where M is the number of genes on the microarray.

(2) Preparing testing dataset. A testing dataset is comprised of microarray data from biological samples of a certain phenotype and corresponding control phenotype, e.g., a certain cancer and control normal samples, or drug-resistant tissues and control drug-sensitive tissues. Arrays from the same platform as the training compendium are recommended. If arrays are from different platforms, the common set of gene probes of the different platforms (e.g., different Affymetrix chips) should be identified and only those genes should be used for further analysis.

(3) Normalize and log transform the gene expression data for the training compendium and testing dataset together. Robust multip-chip analysis (RMA) is recommended for Affymetrix microarray chips. The LOWESS algorithm is recommended for cDNA microarray chips. After normalization, take a log 2 or log 10 transformation of the data and the log-transformed data will be used for MNI calculation.

(4) Compute the average and standard deviation for each gene based on experimental replicates. For experiments lacking replicates and associated standard deviations, compute the standard deviation of each gene across all experimental profiles in the dataset.

(5) Input compendium training dataset, testing gene dataset, gene identifiers, standard deviations, experiment names to MNI algorithm. The MNI parameters are recommended to be optimized for the best results. Run the MNI program by typing “<path to MNI>\MNI.exe” at the operating system command line. Otherwise, run MNI from the Matlab command window by typing in “MNI”. MNI outputs a list of the top ranked genes into a text file which has the same name as the experiment tested. The file resides in the current working directory.

(6) Merge the predicted list of therapeutic target genes. If multiple test samples were used for MNI prediction, the ranking of a gene needs to be merged by taking a mean or median of the rankings of the gene in multiple lists. If one gene (e.g., G) is not existing in one list (e.g., L), then the ranking of G in L will be assigned a high number (e.g., 1000) which will be used for computing the mean or median of the ranking of G.

(7) Merge background gene list from control samples. The background gene list will be merged in the same way as described in step (6).

(8) Identify therapeutic targets by taking a difference between the genes list from step (6) and (7). After identifying the merged gene list of testing samples and control samples, the therapeutic targets are identified by taking the genes common to both lists from the list produced from step (6).

(9) Functional pathway enrichment analysis of the therapeutic targets. The identified therapeutic targets from step (8) are analyzed for their pathway information using gene ontology enrichment analysis or pathway database search (e.g., GO [10], KEGG [11], Ingenuity Pathway [12]).

10) Combination therapy design. Genes from the enriched pathways are selected for RNAi, drug or RNAi-drug therapy. Different strategies can be applied. For example, multiple genes in the same pathway can be selected in combination to modulate one pathway, or genes in multiple pathways can be selected in combination to modulate multiple pathways relevant to a phenotype. The expression of the genes is compared between the test and control samples. For example, if the expression of a gene of interest is upregulated, RNAi-based perturbations can be designed to down-regulate the expression of that gene in order to modulate the phenotype.

### High Throughput Gene Expression Systems

Gene expression data sets useful for the methods disclosed herein can be generated by any number of high throughput or array-based gene expression systems. Typically, the term high throughput refers to a format that performs at least about 50 assays, at least about 100 assays, at least about 500 assays, at least about 1000 assays, at least about 5000 assays, at least about 10,000 assays, or more per day. When enumerating assays, either the number of samples or the number of candidate nucleotide sequences evaluated can be considered. For example, a northern analysis of, e.g., about 100 samples performed in a gridded array, e.g., a dot blot, using a single probe corresponding to a candidate nucleotide sequence can be considered a high throughput assay. More typically, however, such an assay is performed as a series of duplicate blots, each evaluated with a distinct probe corresponding to a different member of the candidate library. Alternatively, methods that simultaneously evaluate expression of about 100 or more candidate nucleotide sequences in one or more samples, or in multiple samples, are considered high throughput.

Numerous technological platforms for performing high throughput expression analysis are known to those of skill in the art. Generally, such methods involve a logical or physical array of either the subject samples, or the candidate library, or both. Common array formats include both liquid and solid phase arrays. For example, assays employing liquid phase arrays, e.g., for hybridization of nucleic acids, binding of antibodies or other receptors to ligand, etc., can be performed in multiwell, or microtiter, plates. Microtiter plates with 96, 384 or 1536 wells are widely available, and even higher numbers of wells, e.g, 3456 and 9600 can be used. In general, the choice of microtiter plates is determined by the methods and equipment, e.g., robotic handling and loading systems, used for sample preparation and analysis. Exemplary systems include, e.g., the ORCA™ system from Beckman-Coulter, Inc. (Fullerton, Calif.) and the Zymate™ systems from Zymark Corporation (Hopkinton, Mass.).

Alternatively, a variety of solid phase arrays can favorably be employed to determine expression patterns in the context of the methods described herein. Exemplary formats include membrane or filter arrays (e.g, nitrocellulose, nylon), pin arrays, and bead arrays (e.g., in a liquid “slurry”). Typically, probes corresponding to nucleic acid or protein reagents that specifically interact with (e.g., hybridize to or bind to) an expression product corresponding to a member of the candidate library are immobilized, for example by direct or indirect cross-linking, to the solid support. Essentially any solid support capable of withstanding the reagents and conditions necessary for performing the particular expression assay can be utilized. For example, functionalized glass, silicon, silicon dioxide, modified silicon, any of a variety of polymers, such as (poly)tetrafluoroethylene, (poly)vinylidenedifluoride, polystyrene, polycarbonate, or combinations thereof can all serve as the substrate for a solid phase array.

A hybridization signal may be amplified using methods known in the art, for example by using a commercial kit, such as a Clontech kit (Glass Fluorescent Labeling Kit), Stratagene kit (Fairplay Microarray Labeling Kit), the Micromax kit (New England Nuclear, Inc.), the Genisphere kit (3DNA Submicro), linear amplification, e.g. as described in U.S. Pat. No. 6,132,997 or described in Hughes, T R, et al., Nature Biotechnology, 19:343 347 (2001) and/or Westin et al. Nat Biotech. 18:199 204.

Alternatively, fluorescently labeled cDNAs are hybridized directly to the microarray using methods known in the art. For example, labeled cDNAs are generated by reverse transcription using Cy3- and Cy5-conjugated deoxynucleotides, and the reaction products purified using standard methods. It is appreciated that the methods for signal amplification of expression data useful for identifying diagnostic nucleotide sets are also useful for amplification of expression data for diagnostic purposes.

Microarray expression may be detected by scanning the microarray with a variety of laser or CCD-based scanners, and extracting features with numerous software packages, for example, Imagene (Biodiscovery), Feature Extraction (Agilent), Scanalyze (Eisen, M. 1999. SCANALYZE User Manual; Stanford Univ., Stanford, Calif. Ver 2.32.), GenePix (Axon Instruments).

In another approach, hybridization to microelectric arrays is performed, e.g. as described in Umek et al (2001) J Mol Diagn. 3:74 84. An affinity probe, e.g. DNA, is deposited on a metal surface. The metal surface underlying each probe is connected to a metal wire and electrical signal detection system. Unlabelled RNA or cDNA is hybridized to the array, or alternatively, RNA or cDNA sample is amplified before hybridization, e.g. by PCR. Specific hybridization of sample RNA or cDNA results in generation of an electrical signal, which is transmitted to a detector. See Westin (2000) Nat Biotech. 18:199 204 (describing anchored multiplex amplification of a microelectronic chip array); Edman (1997) NAR 25:4907 14; Vignali (2000) J Immunol Methods 243:243 55. In another approach, a microfluidics chip is used for RNA sample preparation and analysis. This approach increases efficiency because sample preparation and analysis are streamlined. Briefly, microfluidics may be used to sort specific leukocyte sub-populations prior to RNA preparation and analysis. Microfluidics chips are also useful for, e.g., RNA preparation, and reactions involving RNA (reverse transcription, RT-PCR).

It is understood that the methods of gene expression evaluation, above, although discussed in the context of discovery of diagnostic nucleotide sets, are also applicable for gene expression evaluation when using diagnostic nucleotide sets for, e.g. diagnosis of diseases.

### RNA Interference

As disclosed herein, an RNA interference molecule can be designed to silence one or more candidate-disease mediator, or other target genes, selected from a set of candidate genes by filtering a gene expression data set through a reverse engineered gene regulatory network.

RNA interference (RNAi) is an evolutionally conserved process whereby the expression or introduction of RNA, which has a sequence that is identical or highly similar to a target gene results in the sequence specific degradation or specific post-transcriptional gene silencing (PTGS) of messenger RNA (mRNA) transcribed from that targeted gene 72, thereby inhibiting expression of the target gene. In one embodiment, the RNA is double stranded RNA (dsRNA). This process has been described in plants, invertebrates, and mammalian cells. In nature, RNAi is initiated by the dsRNA-specific endonuclease Dicer, which promotes processive cleavage of long dsRNA into double-stranded fragments termed siRNAs. siRNAs are incorporated into a protein complex (termed “RNA induced silencing complex,” or “RISC”) that recognizes and cleaves target mRNAs. RNAi can also be initiated by introducing nucleic acid molecules, e.g., synthetic siRNAs or RNA interfering agents, to inhibit or silence the expression of target genes.

Short interfering RNA (siRNA) is defined as an RNA agent which functions to inhibit expression of a target gene, e.g., by RNAi. An siRNA may be chemically synthesized, may be produced by in vitro transcription, or may be produced within a host cell. In one embodiment, siRNA is a double stranded RNA (dsRNA) molecule of about 15 to about 40 nucleotides in length, preferably about 15 to about 28 nucleotides, more preferably about 19 to about 25 nucleotides in length, and more preferably about 19, 20, 21, 22, or 23 nucleotides in length, and may contain a 3′ and/or 5′ overhang on each strand having a length of about 0, 1, 2, 3, 4, or 5 nucleotides. The length of the overhang is independent between the two strands, e.g., the length of the overhang on one strand is not dependent on the length of the overhang on the second strand. Preferably the siRNA is capable of promoting RNA interference through degradation or specific post-transcriptional gene silencing (PTGS) of the target messenger RNA (mRNA).

siRNAs also include small hairpin (also called stem loop) RNAs (shRNAs). In one embodiment, these shRNAs are composed of a short (e.g., about 19 to about 25 nucleotide) antisense strand, followed by a nucleotide loop of about 5 to about 9 nucleotides, and the analogous sense strand. Alternatively, the sense strand may precede the nucleotide loop structure and the antisense strand may follow.

The target gene or sequence of the RNA interfering agent may be a cellular gene or genomic sequence, e.g., those described herein as target candidate disease-mediator genes. An siRNA may be substantially homologous to the target gene or genomic sequence, or a fragment thereof. As used in this context, the term “homologous” is defined as being substantially identical, sufficiently complementary, or similar to the target mRNA, or a fragment thereof, to effect RNA interference of the target. In addition to native RNA molecules, RNA suitable for inhibiting or interfering with the expression of a target sequence include RNA derivatives and analogs. Preferably, the siRNA is identical to its target.

The siRNA preferably targets only one sequence. Each of the RNA interfering agents, such as siRNAs, can be screened for potential off-target effects by, for example, expression profiling. Such methods are known to one skilled in the art and are described, for example, in Jackson, A L., Bartz, S R., Schelter, J., Kobayashi, S V., Burchard, J., Mao, M., Li, B., Cavet, G., Linsley, P S., Nature Biotechnology, 21(6):635-637 (2003). In addition to expression profiling, one may also screen the potential target sequences for similar sequences in the sequence databases to identify potential sequences which may have off-target effects. For example, according to Jackson et al. (2003), 15 or perhaps as few as 11 contiguous nucleotides, of sequence identity are sufficient to direct silencing of non-targeted transcripts. Therefore, one may initially screen the proposed siRNAs to avoid potential off-target silencing using the sequence identity analysis by any known sequence comparison methods, such as BLAST.

siRNA sequences are chosen to maximize the uptake of the antisense (guide) strand of the siRNA into RISC and thereby maximize the ability of RISC to target mRNA for degradation. This can be accomplished by scanning for sequences that have the lowest free energy of binding at the 5′-terminus of the antisense strand. The lower free energy leads to an enhancement of the unwinding of the 5′-end of the antisense strand of the siRNA duplex, thereby ensuring that the antisense strand will be taken up by RISC and direct the sequence-specific cleavage of the target gene transcript.

siRNA molecules need not be limited to those molecules containing only RNA, but, for example, further encompasses chemically modified nucleotides and non-nucleotides, and also include molecules wherein a ribose sugar molecule is substituted for another sugar molecule or a molecule which performs a similar function. Moreover, a non-natural linkage between nucleotide residues can be used, such as a phosphorothioate linkage. The RNA strand can be derivatized with a reactive functional group of a reporter group, such as a fluorophore. Particularly useful derivatives are modified at a terminus or termini of an RNA strand, typically the 3′ terminus of the sense strand. For example, the 2′-hydroxyl at the 3′ terminus can be readily and selectively derivatizes with a variety of groups.

Other useful RNA derivatives incorporate nucleotides having modified carbohydrate moieties, such as 2′O-alkylated residues or 2′-O-methyl ribosyl derivatives and 2′-O-fluoro ribosyl derivatives. The RNA bases may also be modified. Any modified base useful for inhibiting or interfering with the expression of a target sequence may be used. For example, halogenated bases, such as 5-bromouracil and 5-iodouracil can be incorporated. The bases may also be alkylated, for example, 7-methylguanosine can be incorporated in place of a guanosine residue. Non-natural bases that yield successful inhibition can also be incorporated.

The most preferred siRNA modifications include 2′-deoxy-2′-fluorouridine or locked nucleic acid (LNA) nucleotides and RNA duplexes containing either phosphodiester or varying numbers of phosphorothioate linkages. Such modifications are known to one skilled in the art and are described, for example, by Braasch et al., Biochemistry, 42: 7967-7975 (2003). Most of the useful modifications to the siRNA molecules can be introduced using chemistries established for antisense oligonucleotide technology. Preferably, the modifications involve minimal 2′-O-methyl modification, preferably excluding such modification. Modifications also preferably exclude modifications of the free 5′-hydroxyl groups of the siRNA.

Synthetic siRNA molecules, including shRNA molecules, can be obtained using a number of techniques known to those of skill in the art. For example, the siRNA molecule can be chemically synthesized or recombinantly produced using methods known in the art, such as using appropriately protected ribonucleoside phosphoramidites and a conventional DNA/RNA synthesizer. Alternatively, several commercial RNA synthesis suppliers are available including, but not limited to, Proligo (Hamburg, Germany), Dharmacon Research (Lafayette, Colo., USA), Pierce Chemical (part of Perbio Science, Rockford, Ill., USA), Glen Research (Sterling, Va., USA), ChemGenes (Ashland, Mass., USA), and Cruachem (Glasgow, UK). As such, siRNA molecules are not overly difficult to synthesize and are readily provided in a quality suitable for RNAi. In addition, dsRNAs can be expressed as stem loop structures encoded by plasmid vectors, retroviruses and lentiviruses (see for example Paddison, P. J. et al., Genes Dev., 16:948-958 (2002); McManus, M. T. et al., RNA, 8:842-850 (2002); Paul, C. P. et al., Nat. Biotechnol., 20:505-508 (2002); Miyagishi, M. et al., Nat. Biotechnol., 20:497-500 (2002); Sui, G. et al., Proc. Natl. Acad. Sci., USA 99:5515-5520 (2002); Brummelkamp, T. et al., Cancer Cell 2:243 (2002); Lee, N. S., et al., Nat. Biotechnol. 20:500-505 (2002); Yu, J. Y., et al., Proc. Natl. Acad. Sci. USA 99:6047-6052 (2002)). These vectors generally have a polIII promoter upstream of the dsRNA and can express sense and antisense RNA strands separately and/or as a hairpin structures. Within cells, Dicer processes the short hairpin RNA (shRNA) into effective siRNA.

The targeted region of the siRNA molecule of the present invention can be selected from a given target gene sequence. Nucleotide sequences may contain 5′ or 3′ UTRs and regions nearby the start codon. One method of designing an siRNA molecule of the present invention involves identifying the 23 nucleotide sequence motif AA(N19)TT (where N can be any nucleotide) and selecting hits with at least 25%, 30%, 35%, 40%, 45%, 50%, 55%, 60%, 65%, 70% or 75% G/C content. The “TT” portion of the sequence is optional. Alternatively, if no such sequence is found, the search may be extended using the motif NA(N21), where N can be any nucleotide. In this situation, the 3′ end of the sense siRNA may be converted to TT to allow for the generation of a symmetric duplex with respect to the sequence composition of the sense and antisense 3′ overhangs. The antisense siRNA molecule may then be synthesized as the complement to nucleotide positions 1 to 21 of the 23 nucleotide sequence motif. The use of symmetric 3′ TT overhangs may be advantageous to ensure that the small interfering ribonucleoprotein particles (siRNPs) are formed with approximately equal ratios of sense and antisense target RNA-cleaving siRNPs. Analysis of sequence databases, including but not limited to the NCBI, BLAST, Derwent and GenSeq as well as commercially available oligosynthesis companies such as Oligoengine®, may also be used to select siRNA sequences against EST libraries to ensure that only one gene is targeted.

### Small Molecules

An identified target gene can be modulated using any number of agents known to one of skill in the art. It is well within the ability of one skilled in the art to administer a small molecule agent for appropriate treatment of disease (e.g., reduction in disease severity).

A variety of different pharmaceutical/therapeutic agents can be used in conjunction with the methods described herein and includes, but is not limited to, small molecules, proteins, antibodies, peptides and nucleic acids. In general, bioactive agents which can be administered include, without limitation: anti-infectives such as antibiotics and antiviral agents; anti-metabolites, anti-mitotics, chemotherapeutic agents (i.e. anticancer agents); anti-rejection agents; analgesics and analgesic combinations; anti-inflammatory agents; anti-thrombotics, fibrinolytics, hormones (e.g., steroids); growth factors (e.g., bone morphogenic proteins (i.e. BMP's 1-7), epidermal growth factor (EGF), fibroblast growth factor (i.e. FGF 1-9), platelet derived growth factor (PDGF), insulin like growth factor (IGF-I and IGF-II), transforming growth factors (i.e. TGF-β-III), growth factor inhibitors, vascular endothelial growth factor (VEGF)); anti-angiogenic proteins such as endostatin, and other naturally derived or genetically engineered proteins, carbohydrates, polysaccharides, glycoproteins, or lipoproteins. Additionally, any type of molecular compound can be administered to target a candidate disease-mediator identified as described herein, such as for example, pharmacological agents, vitamins, sedatives, hypnotics, prostaglandins, and radiopharmaceuticals.

Small molecule agents useful in the practice of the methods as disclosed herein include, but are not limited to, chemicals and peptides to block intracellular signaling cascades, enzymes (kinases), proteasome function, lipid metabolism, cell cycle and membrane trafficking. Small molecule agents can also include various types of endocrine, paracrine, and related or similar polypeptides that can help treat various glandular, growth-related, maturation-related, sexual, cancer and other disorders.

### Dosing and Administration

Those skilled in the art of administration and dose regimes can determine the appropriate dose required for disease management using a desired agent (or plurality of agents) to modulate a gene or gene product identified using a reverse engineered gene regulatory network approach described herein.

The specific therapeutically effective dose level for any particular subject will depend upon a variety of factors including the drug to be administered, the disorder being treated, the severity of the disorder; activity of the specific compound employed; the specific composition employed; the age, body weight, general health, sex and diet of the patient; the time of administration, route of administration, and rate of excretion of the specific compound employed; the duration of the treatment; drugs used in combination or coincidental with the compositions and formulations as disclosed herein which are employed; and like factors well known in the medical arts. For example, it is well within the skill of the art to either start doses of a compound at levels lower than required to achieve the desired therapeutic effect and to gradually increase the dosage until the desired effect is achieved, or start doses of a compound at high levels and to gradually decrease the dosage until the desired effect is achieved, as appropriate for the care of the individual patient.

The compositions can also be administered in prophylactically or therapeutically effective amounts. A prophylactically or therapeutically effective amount means that amount necessary, at least partly, to attain the desired effect, or to delay the onset of, inhibit the progression of, or halt altogether, the onset or progression of the particular disease or disorder being treated. Such amounts will depend, of course, on the particular condition being treated, the severity of the condition and individual patient parameters including age, physical condition, size, weight and concurrent treatment. These factors are well known to those of ordinary skill in the art and can be addressed with no more than routine experimentation. It is preferred generally that a maximum dose be used, that is, the highest safe dose according to sound medical judgment. It will be understood by those of ordinary skill in the art, however, that a lower dose or tolerable dose can be administered for medical reasons, psychological reasons or for virtually any other reasons.

The dose or amount of an agent or a composition to be administered also depends upon the frequency of administration, such as whether administration is once a day, twice a day, 3 times a day or 4 times a day, once a week; or several times a week, for example 2 or 3, or 4 times a week. The amount and frequency of administration depends upon the compositions themselves, their stability and specific activity, as well as the route of administration. Greater amounts of a composition will generally have to be administered for systemic, as opposed to topically administered drugs.

Solid dosage forms for oral administration include, but are not limited to e.g., capsules, tablets, pills, powders and granules. In such solid dosage forms, the agents as disclosed herein may be mixed with at least one inert, pharmaceutically acceptable excipient or carrier, such as sodium citrate or dicalcium phosphate and/or a) fillers or extenders such as starches, lactose, sucrose, glucose, mannitol and silicic acid; b) binders such as carboxymethylcellulose, alginates, gelatin, polyvinylpyrrolidone, sucrose and acacia; c) humectants such as glycerol; d) disintegrating agents such as agar-agar, calcium carbonate, potato or tapioca starch, alginic acid, certain silicates and sodium carbonate; e) solution retarding agents such as paraffin; f) absorption accelerators such as quaternary ammonium compounds; g) wetting agents such as cetyl alcohol and glycerol monostearate; h) absorbents such as kaolin and bentonite clay and i) lubricants such as talc, calcium stearate, magnesium stearate, solid polyethylene glycols, sodium lauryl sulfate and mixtures thereof. In the case of capsules, tablets and pills, the dosage form may also comprise buffering agents. Solid compositions of a similar type may also be employed as fillers in soft and hard-filled gelatin capsules using such excipients as lactose or milk sugar as well as high molecular weight polyethylene glycols and the like. The active components can also be in micro-encapsulated form, if appropriate, with one or more of the above-mentioned excipients. In the preparation of pharmaceutical formulations in the form of dosage units for oral administration the compound selected can be mixed with solid, powdered ingredients, such as lactose, saccharose, sorbitol, mannitol, starch, arnylopectin, cellulose derivatives, gelatin, or another suitable ingredient, as well as with disintegrating agents and lubricating agents such as magnesium stearate, calcium stearate, sodium stearyl fumarate and polyethylene glycol waxes. The mixture is then processed into granules or pressed into tablets.

In addition, compositions for topical (e.g., ocular, oral mucosa, respiratory mucosa) and/or oral administration can be in the form of solutions, suspensions, tablets, pills, capsules, sustained-release formulations, oral rinses, or powders, as known in the art and contemplated herein. The compositions also can include stabilizers and preservatives. For examples of carriers, stabilizers and adjuvants, see, e.g., University of the Sciences in Philadelphia (2005) Remington: The Science and Practice of Pharmacy with Facts and Comparisons, 21st Ed., which is incorporated herein by reference.

The combinations of agents described herein for treatment of a given disease can also be administered in conjunction with one or more additional drugs or therapeutics if so desired. Liquid dosage forms for oral administration include pharmaceutically acceptable emulsions, solutions, suspensions, syrups and elixirs. In addition to the active components, the liquid dosage forms may contain inert diluents commonly used in the art such as, for example, water or other solvents that are compatible with the maintenance of drug in solution or soluble form. Liquid preparations for oral administration can also be prepared in the form of syrups or suspensions, e.g. solutions or suspensions containing from 0.2% to 20% by weight of the active ingredient and the remainder consisting of sugar or sugar alcohols and a mixture of ethanol, water, glycerol, propylene glycol and polyethylene glycol provided that such solvent is compatible with maintaining the micelle form. If desired, such liquid preparations can contain coloring agents, flavoring agents, saccharin and carboxymethyl cellulose or other thickening agents. Liquid preparations for oral administration can also be prepared in the form of a dry powder to be reconstituted with a suitable solvent prior to use. Besides inert diluents, the oral compositions may also include adjuvants such as wetting agents, emulsifying and suspending agents, sweetening, flavoring and perfuming agents.

Transdermal patches can also be used to provide controlled delivery of the formulations and compositions to specific regions of the body. Such dosage forms can be made by dissolving or dispensing the component in the proper medium. Absorption enhancers can also be used to increase the flux of the compound across the skin. The rate can be controlled by either providing a rate-controlling membrane or by dispersing the compound in a polymer matrix or gel.

If so desired, agents and formulations can also be administered via rectal or vaginal administration. Such compositions and formulations as disclosed herein can be in the form of suppositories which can be prepared by mixing the compounds with suitable non-irritating excipients or carriers such as cocoa butter, polyethylene glycol or a suppository wax which are solid at room temperature but liquid at body temperature and therefore melt in the rectum or vaginal cavity and release the active component. Alternatively, compositions and formulations as disclosed herein can be in a form of enteric-coated preparation for oral administration.

In some embodiments, a drug-containing core for coating with an enteric coating film can be prepared using an oleaginous base or by other known formulation methods without using an oleaginous base. In some embodiments, the compositions and formulations as disclosed herein in the form of the drug-containing core for coating with a coating agent may be, for example, tablets, pills and granules. The excipient contained in the core is exemplified by saccharides, such as sucrose, lactose, mannitol and glucose, starch, crystalline cellulose and calcium phosphate. Useful binders include polyvinyl alcohol, hydroxypropyl cellulose, macrogol, Pluronic F-68, gum arabic, gelatin and starch. Useful disintegrants include carboxymethyl cellulose calcium (ECG505), crosslinked carboxymethylcellulose sodium (Ac-Di-Sol), polyvinylpyrrolidone and low-substituted hydroxypropyl cellulose (L-HPC). Useful lubricants and antiflocculants include talc and magnesium stearate. The enteric coating agent can be an enteric polymer which is substantially insoluble in the acidic pH and is at least partially soluble at weaker acidic pH through the basic pH range. The range of acidic pH is about 0.5 to about 4.5, preferably about 1.0 to about 2.0. The range of weaker acidic pH through basic pH is about 5.0 to about 9.0, preferably about 6.0 to about 7.5. Specifically, cellulose acetate phthalate, hydroxypropylmethylcellulose phthalate, hydroxypropylmethyl acetate succinate (Shin-Etsu Chemicals), methacrylic copolymers (Rhon-Pharma, Eudragit® L-30D-55, L100-55, L100, S100, etc.), etc. can be mentioned as examples of enteric coating agents. These materials are effective in terms of stability, even if they are directly used as enteric compositions.

The concentration or content of the therapeutic agent in the composition can be appropriately selected according to the physicochemical properties of the composition. When the composition is in a liquid form, the concentration can be about 0.0005 to about 30% (w/v) and preferably about 0.005 to about 25% (w/v). When the composition is a solid, the content can be about 0.01 to about 90% (w/w) and preferably about 0.1 to about 50% (w/w). If necessary, additives such as a preservative (e.g. benzyl alcohol, ethyl alcohol, benzalkonium chloride, phenol, chlorobutanol, etc.), an antioxidant (e.g. butylhydroxyanisole, propyl gallate, ascorbyl palmitate, alpha-tocopherol, etc.), and a thickener (e.g. lecithin, hydroxypropylcellulose, aluminum stearate, etc.) can be used in the compositions and formulations as disclosed herein. If necessary, one can use an emulsifier with the compositions and formulations as disclosed herein. This can be advantageous where the composition is fat soluble, e.g., as with vitamin A derivatives. Examples of emulsifiers that can be used include pharmaceutically acceptable phospholipids and nonionic surfactants. The emulsifiers can be used individually or in combinations of two or more. The phospholipid includes naturally occurring phospholipids, e.g. egg yolk lecithin, soya lecithin, and their hydrogenation products, and synthetic phospholipids, e.g. phosphatidylcholine, phosphatidylethanolamine, etc. Among them, egg yolk lecithin, soya lecithin, and phosphatidylcholine derived from egg yolk or soybean are preferred. The nonionic surfactant includes macro-molecular surfactants with molecular weights in the range of about 800 to about 20000, such as polyethylene-propylene copolymer, polyoxyethylene alkyl ethers, polyoxyethylene alkylarylethers, hydrogenated castor oil-polyoxyethylene derivatives, polyoxyethylene sorbitan derivatives, polyoxyethylene sorbitol derivatives, polyoxyethylene alkyl ether sulfate, and so on. When used, the proportion of the emulsifier is selected so that the concentration in a final administrable composition will be in the range of about 0.1 to about 10%, preferably about 0.5 to about 5%.

In addition to the above-mentioned components, a stabilizer for further improving the stability of the compositions and formulations as disclosed herein, such as an antioxidant or a chelating agent, an isotonizing agent for adjusting the osmolarity, an auxiliary emulsifier for improving the emulsifying power, and/or an emulsion stabilizer for improving the stability of the emulsifying agent can be incorporated. The isotonizing agent that can be used includes, for example, glycerin, sugar alcohols, monosaccharides, disaccharides, amino acids, dextran, albumin, etc. These isotonizing agents can be used individually or in combination, with two or more. An emulsion stabilizer that can be used, which includes cholesterol, cholesterol esters, tocopherol, albumin, fatty acid amide derivatives, polysaccharides, polysaccharide fatty acid ester derivatives, etc.

The compositions and formulations as disclosed herein can further comprise a viscogenic substance which can adhere to the digestive tract mucosa due to its viscosity expressed on exposure to water. Examples of such viscogenic substances include, but are not particularly limited as long as it is pharmaceutically acceptable, polymers (e.g. polymers or copolymers of acrylic acids and their salts) and natural-occurring viscogenic substances (e.g. mucins, agar, gelatin, pectin, carrageenin, sodium alginate, locust bean gum, xanthan gum, tragacanth gum, arabic gum, chitosan, pullulan, waxy starch, sucralfate, curdlan, cellulose, and their derivatives). Furthermore, for controlling the release of the active drug or for formulation purposes, the additives conventionally used for preparing oral compositions can be added. Example of the additives include excipients (e.g. lactose, corn starch, talc, crystalline cellulose, sugar powder, magnesium stearate, mannitol, light anhydrous silicic acid, magnesium carbonate, calcium carbonate, L-cysteine, etc.), binders (e.g. starch, sucrose, gelatin, arabic gum powder, methylcellulose, carboxymethylcellulose, carboxymethylcellulose sodium, hydroxypropylcellulose, hydroxypropylmethylcellulose, polyvinylpyrrolidone, pullulan, dextrin, etc.), disintegrators (e.g. carboxymethylcellulose calcium, low-substituted hydroxypropylcellulose, croscarmellose sodium, etc.), anionic surfactants (e.g. sodium alkylsulfates etc.), nonionic surfactants (e.g. polyoxyethylene sorbitan fatty acid esters, polyoxyethylene fatty acid esters, polyoxyethylene-castor oil derivatives, etc.), antacids and mucous membrane protectants (e.g. magnesium hydroxide, magnesium oxide, aluminum hydroxide, aluminum sulfate, magnesium metasilicate aluminate, magnesium silicate aluminate, sucralfate, etc.), cyclodextrin and the corresponding carboxylic acid (e.g. maltosyl-beta-cyclodextrin, maltosyl-beta-cyclodextrin-carboxylic acid, etc.), colorants, corrigents, adsorbents, antiseptics, moistening agents, antistatic agents, disintegration retardants, and so on. The proportion of these additives can be appropriately selected from the range that can keep the stability and absorption of the basis.

### Efficacy Measurement

The efficacy of the agent (or plurality of agents) useful in the methods described herein can be determined, for example by a reduction in symptoms, e.g., a cancer drug to which tolerance has developed in a subject can become effective in tumor reduction (e.g., size or decreased metastasis) following treatment with a combination of agents as described herein.

Efficacy of an agent can be assessed, for example by measuring disease progression, disease remission, symptom severity, reduction in pain, tumor size, quality of life, dose of medication required to sustain a treatment effect, level of a disease marker or any other measurable parameter appropriate for a given disease being treated. It is well within the ability of one skilled in the art to monitor efficacy of an agent by measuring any one of these parameters, or any combination of parameters. Efficacy for any given drug or formulation of that drug can also be judged using an experimental animal model. When using an experimental animal model, efficacy of treatment is evidenced when a reduction in a marker or symptom of e.g., the disease is observed.

Alternatively, the efficacy can be measured by a reduction in the severity of disease as determined by one skilled in the art of diagnosis based on a measurable disease severity grading scale such as, for example the NYHA Classes of Heart failure. In this example, there are four stages of heart failure graded from mild to severe, based on symptoms such as e.g., the ability to carry on physical activity, shortness of breath, and palpitations. Efficacy can be measured in this example by the movement of a patient from e.g., a Class IV (severe) heart failure profile to a Class III, Class II, or Class I heart failure profile. Similar grading scales exist, for example, for heart disease, diabetic retinopathy, systemic sclerosis, Clostridium difficile-Associated Disease, Lipodystrophy (Lipodystrophy Severity Grading Scale), HIV (HIV Outpatient Study scale) and various cancers among others. Such scales can be used to determine a patient's progress in response to treatment. Any positive change resulting in e.g., lessening of severity of disease measured using the appropriate scale, represents adequate treatment using agents, which target identified candidate disease-mediator genes as described herein.

The treatments described herein can be administered and monitored by one of skill in the art of medicine.

As used in this specification and the appended claims, the singular forms “a,” “an,” and “the” include plural references unless the context clearly dictates otherwise. Thus for example, references to “the method” includes one or more methods, and/or steps of the type described herein and/or which will become apparent to those persons skilled in the art upon reading this disclosure and so forth.

Unless specifically stated otherwise, throughout the present disclosure, terms such as “processing”, “computing”, “calculating”, “determining”, “filtering”, “assigning”, “enriching”, “outputting” or the like, may refer to the actions and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include an apparatus for performing the operations therein. Such apparatus may be specially constructed for the desired purposes, or it may comprise a general-purpose computer selectively activated or reconfigured by a computer program stored in the computer.

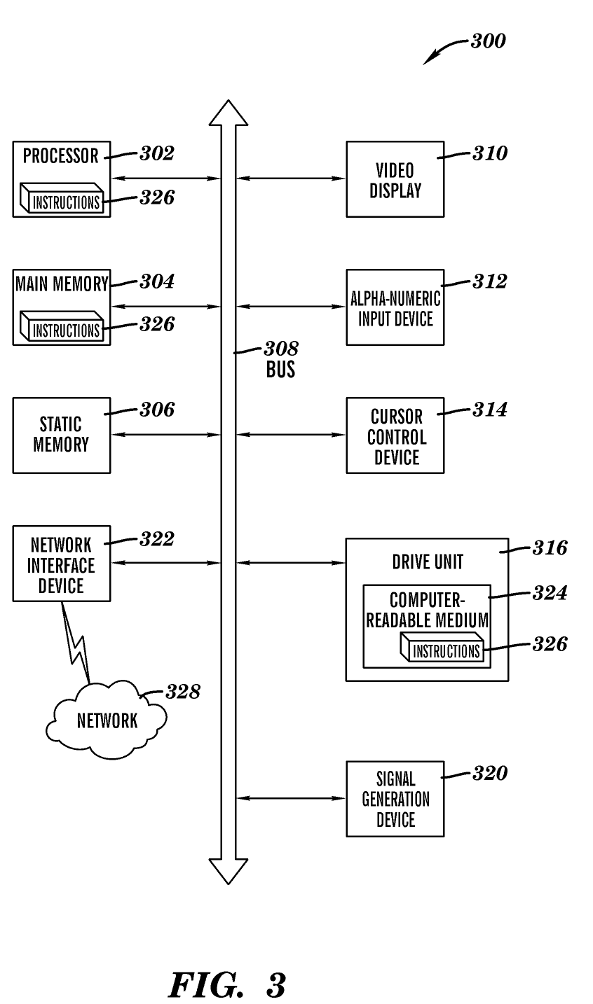

FIG. 3 shows a diagrammatic representation of a machine in the exemplary form of a computer system 300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server, personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 300 includes a processor 302 (e.g., a central processing unit (CPU), a graphics processing unit (GPU) or both), a main memory 304 (e.g., read only memory (ROM), flash memory, dynamic random access memory (DRAM) such as synchronous DRAM (SDRAM) or Rambus DRAM (RDRAM), etc.) and a static memory 306 (e.g., flash memory, static random access memory (SRAM), etc.), which communicate with each other via a bus 308.

The computer system 300 may further include a video display unit 310 (e.g., a liquid crystal display (LCD) or a cathode ray tube (CRT)). The computer system 300 also includes an alphanumeric input device 312 (e.g., a keyboard), a cursor control device 314 (e.g., a mouse), a disk drive unit 316, a signal generation device 620 (e.g., a speaker) and a network interface device 322.

The disk drive unit 316 includes a machine-readable medium 324 on which is stored one or more sets of instructions (e.g., software 326) embodying any one or more of the methodologies or functions described herein. The software 326 may also reside, completely or at least partially, within the main memory 304 and/or within the processor 302 during execution of the software 326 by the computer system 300.

The software 326 may further be transmitted or received over a network 328 via the network interface device 322.

While the machine-readable medium 324 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media. The term “machine-readable storage medium” shall accordingly be taken to include, but not be limited to, solid-state memories and optical and magnetic media (e.g., any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions or data, and capable of being coupled to a computer system bus).

Aspects of the invention have been described through functional modules, which are defined by executable instructions recorded on computer readable media which cause a computer to perform method steps when executed. The modules have been segregated by function for the sake of clarity. However, it should be understood that the modules need not correspond to discreet blocks of code and the described functions can be carried out by the execution of various code portions stored on various media and executed at various times.

It is understood that the foregoing detailed description and the following examples are illustrative only and are not to be taken as limitations upon the scope of the invention. Various changes and modifications to the disclosed embodiments, which will be apparent to those skilled in the art, may be made without departing from the spirit and scope of the present invention. Further, all patents, patent applications, and publications identified are expressly incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents are based on the information available to the applicants and do not constitute any admission as to the correctness of the dates or contents of these documents.

The present invention may be as defined in any one of the following numbered paragraphs.
1. A computer-implemented method comprising:
   (a) filtering a test gene expression data set from a sample through a reverse engineered gene regulatory network derived for an organism to identify a set of candidate target genes at a computer processor;
   (b) assigning a z-score to each target gene in the set of candidate target genes, and ranking the target genes according to the z-score at the computer processor;
   (c) enriching those target genes with the highest z-scores using gene ontology enrichment analysis or pathway database search at the computer processor.
2. The method of paragraph 1, wherein the reverse engineered gene regulatory network is derived from a compendium of gene expression data sets derived from the organism.
3. The method of paragraph 1, further comprising constructing the reverse engineered gene regulatory network at the computer processor, and wherein construction of the reverse engineered gene regulatory network comprises:
   (a) providing a biological system or a plurality of biological systems, each biological system comprising a biological network comprising a plurality of biochemical species having activities;
   (b) perturbing the activity of at least one of the biochemical species, thereby causing a response in the biological network;
   (c) allowing the biological network to reach a steady state;
   (d) determining the response of at least one of the biochemical species in the biological network; and
   (e) estimating parameters of a model representing the biological network, whereby the reverse-engineered gene regulatory network is constructed.
4. The method of paragraph 2, wherein the compendium of gene expression data sets comprises gene expression data from a plurality of conditions of the organism.
5. The method of paragraph 1, wherein the pathway database search comprises searching pathway maps or applying a pathway analysis.
6. The method of paragraph 1, further comprising targeting a candidate disease-mediator gene of the set of candidate disease-mediator genes for modulation with an agent.
7. The method of paragraph 1, further comprising targeting a candidate disease-mediator gene of the set of candidate disease-mediator genes for modulation with a plurality of agents.
8. The method of paragraph 5, comprising targeting a plurality of candidate disease-mediator genes for modulation with an agent, or a plurality of agents.
9. The method of paragraph 5, wherein the modulation comprises inhibition of the candidate disease-mediator gene.
10. The method of paragraph 7, wherein the inhibition comprises treating a subject with an agent selected from the group consisting of an RNA interference molecule, a small molecule, an antibody or antigen-binding fragment thereof, a peptide, a polypeptide, an oligonucleotide, an aptamer, a peptide nucleic acid, or a nucleic acid.
11. The method of paragraph 1 wherein the enriching those target genes with the highest z-scores comprises enriching a set of 100 to 300 genes with the highest z-scores.
12. The method of paragraph 1 wherein the enriching identifies a set of candidate disease-mediator genes.
13. The method of paragraph 1 wherein the enriching provides an enriched set of candidate drug-influenced genes
14. The method of paragraph 13 wherein the enriched set of candidate drug-influenced genes represents potential therapy targets that are predicted to have a combined efficacy for treating a given disease that is greater than the added efficacy of each agent alone.
15. The method of paragraph 1 wherein the sample represents a disease population, and wherein increasing z-scores correlate with increasing likelihood of direct participation in disease pathology.
16. The method of paragraph 1 wherein the sample is derived from an individual or set of individuals treated with a first drug, and wherein increasing z-scores correlate with increasing likelihood of direct influence by treatment with the first drug.
17. The method of paragraph 1, wherein the sample is derived from a subject or set of subjects treated with a first drug, and wherein the set of candidate genes that are identified are genes that are modulated in an individual following treatment with a first drug.
18. The method of paragraph 17, wherein the enriching provides an enriched set of candidate drug-influenced genes representing genes predicted to be involved in an individual's response to the first drug.
19. The method of paragraph 18, further comprising:
   (d) administering to an individual in need of treatment for a the disease the first drug and an agent that modulates a gene or product thereof represented in the enriched set of candidate drug-influenced genes, wherein modulation of the gene enhances the efficacy of the first drug for the treatment of the disease.
20. The method of paragraph 17, wherein efficacy of the first drug is enhanced by increasing the in vivo half-life of the first drug.
21. The method of paragraph 17, wherein efficacy of the first drug is enhanced by slowing metabolism of the first drug.
22. The method of paragraph 17, wherein efficacy of the first drug is enhanced by decreasing clearance of the first drug.
23. The method of paragraph 17, wherein efficacy of the first drug is enhanced by decreasing a side effect of the first drug.
24. The method of paragraph 17, wherein efficacy of the first drug is enhanced by increasing bioavailability of the first drug.
25. The method of paragraph 1, wherein the sample is derived from an individual treated with a first drug, and wherein a set of candidate gene targets that are upregulated in the individual are identified.
26. The method of paragraph 25, wherein the enriching provides an enriched set of candidate drug-influenced genes representing genes predicted to be involved in an individual's response to the first drug.
27. The method of paragraph 26, administering the first drug and an agent that modulates the activity of a candidate drug-influenced gene or a product thereof to the individual, wherein the administering enhances the response of the individual to the first drug.
28. A computer readable storage medium containing executable instructions which cause a data processing system to perform a method, the instructions comprising:
   (a) instructions for receiving test gene expression data from a sample;
   (b) instructions for filtering the test gene expression data through a reverse engineered gene regulatory network derived for the organism to identify a set of candidate target genes;
   (c) instructions for assigning a z-score to each target gene in the set of candidate target genes, and ranking the target genes according to z-score; and
   (d) instructions for enriching those target genes with the highest z-scores using gene ontology enrichment analysis or pathway database search
29. The computer readable storage medium of paragraph 28, wherein the sample represents a disease population and the increasing z-scores correlate with increasing likelihood of direct participation in disease pathology, and further comprising:
   (e) instructions for outputting identities of a set of candidate disease-mediator genes to a computer-readable memory or to an output device.
30. The computer readable storage medium of paragraph 28 wherein the sample is derived from an individual or set of individuals treated with a first drug and the increasing z-scores correlate with increasing likelihood of direct influence by treatment with the first drug, and further comprising:
   (e) instructions for outputting identities of an enriched set of candidate drug-influenced genes to a computer-readable memory or to an output device.
31. The computer readable storage medium of paragraph 28 wherein the sample is derived from a subject or set of subjects treated with a first drug and increasing z-scores correlate with increasing likelihood of direct influence by the first drug, and further comprising:
   (e) instructions for outputting identities of an enriched set of candidate drug influenced genes representing a set of candidate targets for enhancing the efficacy of the first drug.
32. The computer readable storage medium of paragraph 28 wherein the sample is derived from an individual treated with a first drug, and further comprising:
   (e) instructions for outputting identities of an enriched set of candidate drug influenced genes represents genes predicted to be involved in an individual's response to the first drug.
33. A computer system for identifying candidate disease mediator genes, the computer system comprising:
   (a) memory configured to store test gene expression data from a sample obtained from an organism; and
   (b) a computer processor coupled to the memory and configured to filter the test gene expression data through a reverse engineered gene regulatory network derived for the organism to identify a set of candidate target genes, assign a z-score to each target gene in the set of candidate target genes, rank the target genes according to z-score, and enrich those target genes with the highest z-scores using gene ontology enrichment analysis or pathway database search.
34. The computer system of paragraph 33, wherein the sample represents a disease population, the increasing z-scores correlate with increasing likelihood of direct participation in disease pathology, and wherein the computer processor is further configured to store data regarding a set of identified candidate disease-mediator genes.
35. The computer system of paragraph 33 wherein the sample is derived from an individual or set of individuals treated with a first drug and the increasing z-scores correlate with increasing likelihood of direct influence by treatment with the first drug, and wherein the computer processor is further configured to store data regarding an enriched set of candidate drug-influenced genes.
36. The computer system of paragraph 33 wherein the sample is derived from a subject or set of subjects treated with a first drug and increasing z-scores correlate with increasing likelihood of direct influence by the first drug, and wherein the computer processor is further configured to store data regarding a set of identified candidate targets representing a set of candidate targets for enhancing the efficacy of the first drug.
37. The computer system of paragraph 33 wherein the sample is derived from an individual treated with a first drug, and wherein the computer processor is further configured to store data regarding a set of candidate targets representing genes predicted to be involved in an individual's response to the first drug.
38. A method for identifying candidate disease mediator genes, the method comprising the steps of:
   (a) filtering a test gene expression data set from a sample representing a disease population through a reverse engineered gene regulatory network derived for an organism to identify a set of candidate target genes;
   (b) assigning a z-score to each target gene in the set of candidate target genes, and ranking the target genes according to z-score, wherein increasing z-scores correlate with increasing likelihood of direct participation in disease pathology;
   (c) enriching those target genes with the highest z-scores for those most likely to be directly involved in the disease using gene ontology enrichment analysis or pathway database search, wherein the enriching identifies a set of candidate disease-mediator genes.
39. The method of paragraph 38, wherein the reverse engineered gene regulatory network is derived from a compendium of gene expression data sets derived from the organism.
40. The method of paragraph 38, wherein the reverse engineered gene regulatory network is constructed using the steps of:
   (a) providing a biological system or a plurality of biological systems, each biological system comprising a biological network comprising a plurality of biochemical species having activities;
   (b) perturbing the activity of at least one of the biochemical species, thereby causing a response in the biological network;
   (c) allowing the biological network to reach a steady state;
   (d) determining the response of at least one of the biochemical species in the biological network; and
   (e) estimating parameters of a model representing the biological network, whereby the reverse-engineered gene regulatory network is constructed.
41. The method of paragraph 38, wherein the compendium of gene expression data sets comprises gene expression data from a plurality of conditions of the organism.
42. The method of paragraph 38, wherein the pathway database search comprises searching pathway maps or applying a pathway analysis.
43. The method of paragraph 38, further comprising targeting a candidate disease-mediator gene of the set of candidate disease-mediator genes for modulation with an agent.
44. The method of paragraph 38, further comprising targeting a candidate disease-mediator gene of the set of candidate disease-mediator genes for modulation with a plurality of agents.
45. The method of paragraph 43, comprising targeting a plurality of candidate disease-mediator genes for modulation with an agent, or a plurality of agents.
46. The method of paragraph 43, wherein the modulation comprises inhibition of the candidate disease-mediator gene.
47. The method of paragraph 46, wherein the inhibition comprises treating a subject with an agent selected from the group consisting of an RNA interference molecule, a small molecule, an antibody or antigen-binding fragment thereof, a peptide, a polypeptide, an oligonucleotide, an aptamer, a peptide nucleic acid, or a nucleic acid.
48. The method of paragraph 38 wherein the enriching those target genes with the highest z-scores comprises enriching a set of 100 to 300 genes with the highest z-scores.
49. A method for predicting synergistic drug combinations for treating a given disease, the method comprising the steps of:
   (a) filtering a test gene expression data set from a sample derived from an individual or set of individuals treated with a first drug through a reverse engineered gene regulatory network derived for an organism to identify a set of candidate genes influenced by the first drug,
   (b) assigning a z-score to each candidate gene in the set of candidate genes, and ranking the candidate genes according to z-score, wherein increasing z-scores correlate with increasing likelihood of direct influence by treatment with the first drug;
   (c) enriching those candidate genes with the highest z-scores using gene ontology enrichment analysis or pathway database search, wherein the enriching provides an enriched set of candidate drug-influenced genes, and
   wherein the enriched set of candidate drug-influenced genes represents potential therapy targets that are predicted to have a combined efficacy for treating a given disease that is greater than the added efficacy of each agent alone.
50. The method of paragraph 49, wherein the reverse engineered gene regulatory network is derived from a compendium of gene expression data sets derived from the organism.
51. The method of paragraph 49, wherein the reverse engineered gene regulatory network is constructed using the steps of:
   (a) providing a biological system or a plurality of biological systems, each biological system comprising a biological network comprising a plurality of biochemical species having activities;
   (b) perturbing the activity of at least one of the biochemical species, thereby causing a response in the biological network;
   (c) allowing the biological network to reach a steady state;
   (d) determining the response of at least one of the biochemical species in the biological network; and
   (e) estimating parameters of the model.
52. The method of paragraph 49, wherein the compendium of gene expression data sets comprises gene expression data from a plurality of conditions of the organism.
53. The method of paragraph 49, wherein the pathway database search comprises searching pathway maps or applying a pathway analysis.
54. The method of paragraph 49, further comprising targeting a candidate disease-mediator gene of the set of candidate disease-mediator genes for modulation with an agent.
55. The method of paragraph 49, comprising targeting a plurality of candidate disease-mediator genes for modulation with an agent, or a plurality of agents.
56. The method of paragraph 54, further comprising targeting a candidate disease-mediator gene of the set of candidate disease-mediator genes for modulation with a plurality of agents.
57. The method of paragraph 54, wherein the modulation comprises inhibition of the candidate disease-mediator gene.
58. The method of paragraph 57, wherein the inhibition comprises treating a subject with an agent selected from the group consisting of an RNA interference molecule, a small molecule, an antibody or antigen-binding fragment thereof, a peptide, a polypeptide, an aptamer, a peptide nucleic acid, an oligonucleotide, or a nucleic acid.
59. A method for enhancing efficacy of a drug used to treat a given disease, the method comprising the steps of:
   (a) filtering a test gene expression data set from a sample derived from a subject or set of subjects treated with a first drug through a reverse engineered gene regulatory network derived for an organism to identify a set of candidate genes that are modulated in the individual following treatment with a first drug,
   (b) assigning a z-score to each gene in the set of candidate genes, and ranking the candidate genes according to z-score, wherein increasing z-scores correlate with increasing likelihood of direct influence by the first drug;
   (c) enriching those candidate genes with the highest z-scores using gene ontology enrichment analysis or pathway database search, wherein the enriching provides an enriched set of candidate drug-influenced genes representing genes predicted to be involved in an individual's response to the first drug; and
   (d) administering to an individual in need of treatment for a the disease the first drug and an agent that modulates a gene or product thereof represented in the enriched set of candidate drug-influenced genes, wherein modulation of the gene enhances the efficacy of the first drug for the treatment of the disease.
60. The method of paragraph 59, wherein the reverse engineered gene regulatory network is derived from a compendium of gene expression data sets derived from the organism.
61. The method of paragraph 59, wherein the reverse engineered gene regulatory network is constructed using the steps of:
   (a) providing a biological system or a plurality of biological systems, each biological system comprising a biological network comprising a plurality of biochemical species having activities;
   (b) perturbing the activity of at least one of the biochemical species, thereby causing a response in the biological network;
   (c) allowing the biological network to reach a steady state;
   (d) determining the response of at least one of the biochemical species in the biological network; and
   (e) estimating parameters of the model.
62. The method of paragraph 59, wherein the compendium of gene expression data sets comprises gene expression data from a plurality of conditions of the organism.
63. The method of paragraph 59, wherein the pathway database search comprises searching pathway maps or applying a pathway analysis.
64. The method of paragraph 59, further comprising targeting a candidate disease-mediator gene of the set of candidate disease-mediator genes for modulation with an agent.
65. The method of paragraph 59, further comprising targeting a candidate disease-mediator gene of the set of candidate disease-mediator genes for modulation with a plurality of agents.
66. The method of paragraph 59, comprising targeting a plurality of candidate disease-mediator genes for modulation with an agent, or a plurality of agents.
67. The method of paragraph 59, wherein the modulation comprises inhibition of the candidate disease-mediator gene.
68. The method of paragraph 67, wherein the inhibition comprises treating a subject with an agent selected from the group consisting of an RNA interference molecule, a small molecule, an antibody or antigen-binding fragment thereof, a peptide, a polypeptide, an oligonucleotide, an aptamer, a peptide nucleic acid, or a nucleic acid.
69. The method of paragraph 59, wherein efficacy of the first drug is enhanced by increasing the in vivo half-life of the first drug.
70. The method of paragraph 59, wherein efficacy of the first drug is enhanced by slowing metabolism of the first drug.
71. The method of paragraph 59, wherein efficacy of the first drug is enhanced by decreasing clearance of the first drug.
72. The method of paragraph 59, wherein efficacy of the first drug is enhanced by decreasing a side effect of the first drug.
73. The method of paragraph 59, wherein efficacy of the first drug is enhanced by increasing bioavailability of the first drug.
74. A method for tailoring a drug therapy to an individual, the method comprising the steps of:
   (a) filtering a gene expression data set from a sample derived from an individual treated with a first drug through a reverse engineered gene regulatory network derived for an organism to identify a set of candidate gene targets that are upregulated in the individual;
   (b) assigning a z-score to each target gene in the set of candidate gene targets, and ranking the target genes according to z-score;
   (c) enriching the target genes with highest z-score using gene ontology enrichment analysis or pathway database search, wherein the enriching provides an enriched set of candidate drug-influenced genes representing genes predicted to be involved in an individual's response to the first drug; and
   (d) administering the first drug and an agent that modulates the activity of a candidate drug-influenced gene or a product thereof to the individual, wherein the administering enhances the response of the individual to the first drug.
75. The method of paragraph 74, wherein the reverse engineered gene regulatory network is derived from a compendium of gene expression data sets derived from the organism.
76. The method of paragraph 74, wherein the reverse engineered gene regulatory network is constructed using the steps of:
   (a) providing a biological system or a plurality of biological systems, each biological system comprising a biological network comprising a plurality of biochemical species having activities;
   (b) perturbing the activity of at least one of the biochemical species, thereby causing a response in the biological network;
   (c) allowing the biological network to reach a steady state;
   (d) determining the response of at least one of the biochemical species in the biological network; and
   (e) estimating parameters of the model.
77. The method of paragraph 74, wherein the compendium of gene expression data sets comprises gene expression data from a plurality of conditions of the organism.
78. The method of paragraph 74, wherein the pathway database search comprises searching pathway maps or applying a pathway analysis.
79. The method of paragraph 74, further comprising targeting a candidate disease-mediator gene of the set of candidate disease-mediator genes for modulation with an agent.
80. The method of paragraph 74, comprising targeting a plurality of candidate disease-mediator genes for modulation with an agent, or a plurality of agents.
81. The method of paragraph 74, further comprising targeting a candidate disease-mediator gene of the set of candidate disease-mediator genes for modulation with a plurality of agents.
82. The method of paragraph 74, wherein the modulation comprises inhibition of the candidate disease-mediator gene.
83. The method of paragraph 74, wherein the inhibition comprises treating a subject with an agent selected from the group consisting of an RNA interference molecule, a small molecule, an antibody or antigen-binding fragment thereof, a peptide, a polypeptide, an oligonucleotide, an aptamer, a peptide nucleic acid, or a nucleic acid.
84. A computer-readable medium comprising computer-executable instructions for identifying a set of candidate disease mediator genes, the medium comprising:
   (a) instructions for receiving test gene expression data from a sample representing a disease population of an organism;
   (b) instructions for filtering the test gene expression through a reverse engineered gene regulatory network derived for the organism to identify a set of candidate target genes;
   (c) instructions for assigning a z-score to each target gene in the set of candidate target genes, and ranking the target genes according to z-score, wherein increasing z-scores correlate with increasing likelihood of direct participation in disease pathology;
   (d) instructions for enriching those target genes with the highest z-scores for those most likely to be directly involved in the disease using gene ontology enrichment analysis or pathway database search, wherein the enriching identifies a set of candidate disease-mediator genes; and
   (e) instructions for outputting the identities of the set of candidate disease-mediator genes to a computer-readable memory or to an output device.
85. A computer system for identifying candidate disease mediator genes, the computer system comprising:
   (a) a user interface;
   (b) a computer processor capable of executing computer executable instructions encoded on a computer-readable medium;
   (c) a computer readable medium comprising:
      (i) instructions for receiving test gene expression data from a sample representing a disease population of an organism;
      (ii) instructions for filtering the test gene expression through a reverse engineered gene regulatory network derived for the organism to identify a set of candidate target genes;
      (iii) instructions for assigning a z-score to each target gene in the set of candidate target genes, and ranking the target genes according to z-score, wherein increasing z-scores correlate with increasing likelihood of direct participation in disease pathology;
      (iv) instructions for enriching those target genes with the highest z-scores for those most likely to be directly involved in the disease using gene ontology enrichment analysis or pathway database search, wherein the enriching identifies a set of candidate disease-mediator genes; and
      (v) instructions for outputting the identities of the set of candidate disease-mediator genes to a computer-readable memory or to the user interface.
86. A computer-readable medium comprising computer-executable instructions for predicting synergistic drug combinations for treating a given disease, the medium comprising:
   (a) instructions for receiving a test gene expression data set from a sample derived from an individual or set of individuals treated with a first drug;
   (b) instructions for filtering the gene expression data set through a reverse engineered gene regulatory network derived for an organism to identify a set of candidate genes influenced by the first drug;
   (c) instructions for assigning a z-score to each candidate gene in the set of candidate genes, and for ranking the candidate genes according to z-score, wherein increasing z-scores correlate with increasing likelihood of direct influence by treatment with the first drug;
   (d) instructions for enriching those candidate genes with the highest z-scores using gene ontology enrichment analysis or pathway database search, wherein the enriching provides an enriched set of candidate drug-influenced genes, and wherein the enriched set of candidate drug-influenced genes represents potential therapy targets that are predicted to have a combined efficacy for treating a given disease that is greater than the added efficacy of each agent alone; and
   (e) instructions for outputting the identities of the set of candidate drug-influenced genes to a computer-readable memory or to an output device.
87. A computer system for predicting synergistic drug combinations for treating a given disease, the system comprising:
   (a) a user interface;
   (b) a computer processor capable of executing computer executable instructions encoded on a computer-readable medium;
   (c) a computer readable medium comprising:
      (i) instructions for receiving a test gene expression data set from a sample derived from an individual or set of individuals treated with a first drug;
      (ii) instructions for filtering the gene expression data set through a reverse engineered gene regulatory network derived for an organism to identify a set of candidate genes influenced by the first drug;
      (iii) instructions for assigning a z-score to each candidate gene in the set of candidate genes, and for ranking the candidate genes according to z-score, wherein increasing z-scores correlate with increasing likelihood of direct influence by treatment with the first drug;
      (iv) instructions for enriching those candidate genes with the highest z-scores using gene ontology enrichment analysis or pathway database search, wherein the enriching provides an enriched set of candidate drug-influenced genes, and wherein the enriched set of candidate drug-influenced genes represents potential therapy targets that are predicted to have a combined efficacy for treating a given disease that is greater than the added efficacy of each agent alone; and
      (v) instructions for outputting the identities of the set of candidate drug-influenced genes to a computer-readable memory or to an output device.
88. A computer-readable medium comprising computer-executable instructions for identifying targets for enhancing the efficacy of a drug used to treat a given disease, the medium comprising:
   (a) instructions for receiving a test gene expression data set obtained from a sample derived from a subject or set of subjects treated with a first drug;
   (b) instructions for filtering a test gene expression data set from a sample derived from a subject or set of subjects treated with a first drug through a reverse engineered gene regulatory network derived for an organism to identify a set of candidate genes that are modulated in the subject of set of subjects following treatment with the first drug;
   (c) instructions for assigning a z-score to each gene in the set of candidate genes, and for ranking the candidate genes according to z-score, wherein increasing z-scores correlate with increasing likelihood of direct influence by the first drug;
   (d) instructions for enriching those candidate genes with the highest z-scores using gene ontology enrichment analysis or pathway database search, wherein the enriching provides an enriched set of candidate drug-influenced genes representing genes predicted to be involved in an individual's response to the first drug; and
   (e) instructions for outputting the identities of the enriched set of candidate drug-influenced genes to a computer-readable memory or to a user interface, wherein the enriched set of candidate drug influenced genes represents a set of candidate targets for enhancing the efficacy of the first drug.
89. A computer system for identifying targets for enhancing the efficacy of a drug used to treat a given disease, the system comprising:
   (a) a user interface;
   (b) a computer processor capable of executing computer executable instructions encoded on a computer-readable medium;
   (c) a computer readable medium comprising:
      (i) instructions for receiving a test gene expression data set obtained from a sample derived from a subject or set of subjects treated with a first drug;
      (ii) instructions for filtering the test gene expression data set from a sample derived from a subject or set of subjects treated with a first drug through a reverse engineered gene regulatory network derived for an organism to identify a set of candidate genes that are modulated in the subject of set of subjects following treatment with the first drug,
      (iii) instructions for assigning a z-score to each gene in the set of candidate genes, and for ranking the candidate genes according to z-score, wherein increasing z-scores correlate with increasing likelihood of direct influence by the first drug;
      (iv) instructions for enriching those candidate genes with the highest z-scores using gene ontology enrichment analysis or pathway database search, wherein the enriching provides an enriched set of candidate drug-influenced genes representing genes predicted to be involved in an individual's response to the first drug; and
      (v) instructions for outputting the identities of the enriched set of candidate drug-influenced genes to a computer-readable memory or to a user interface, wherein the enriched set of candidate drug influenced genes represents a set of candidate targets for enhancing the efficacy of the first drug.
90. A computer-readable medium comprising instructions for identifying targets for tailoring a drug therapy to an individual, the medium comprising:
   (a) instructions for receiving a gene expression data set from a sample derived from an individual treated with a first drug;
   (b) instructions for filtering the gene expression data set through a reverse engineered gene regulatory network derived for an organism, to identify a set of candidate gene targets that are upregulated in the individual,
   (c) instructions for assigning a z-score to each target gene in the set of candidate gene targets, and for ranking the target genes according to z-score,
   (d) instructions for enriching the target genes with highest z-score using gene ontology enrichment analysis or pathway database search, wherein the enriching provides an enriched set of candidate drug-influenced genes representing genes predicted to be involved in an individual's response to the first drug; and
   (e) instructions for outputting the enriched set of candidate drug-influenced genes to a memory or to a user interface, wherein the set represents targets for tailoring the individual's response to the first drug.
91. A computer system for identifying targets for tailoring a drug therapy to an individual, the system comprising:
   (a) a user interface;
   (b) a computer processor capable of executing computer executable instructions encoded on a computer-readable medium;
   (c) a computer readable medium comprising:
      (i) instructions for receiving a gene expression data set from a sample derived from an individual treated with a first drug;
      (ii) instructions for filtering the gene expression data set through a reverse engineered gene regulatory network derived for an organism, to identify a set of candidate gene targets that are upregulated in the individual,
      (iii) instructions for assigning a z-score to each target gene in the set of candidate gene targets, and for ranking the target genes according to z-score,
      (iv) instructions for enriching the target genes with highest z-score using gene ontology enrichment analysis or pathway database search, wherein the enriching provides an enriched set of candidate drug-influenced genes representing genes predicted to be involved in an individual's response to the first drug; and
      (v) instructions for outputting the enriched set of candidate drug-influenced genes to a memory or to the user interface, wherein the set represents targets for tailoring the individual's response to the first drug.

### EXAMPLES

### Example 1

### Case Study: Therapeutic Targets for Improving Drug Sensitivity for Chemotherapy Treating Leukemia

Chemotherapy has been effective in treating childhood Acute Lymphoblastic Leukemia (ALL). However children with drug-resistant ALL cells often show poor prognosis and have low survival rates. The objective of this study was to identify therapeutic targets that could be perturbed either chemically or genetically to sensitize ALL cells to current chemotherapy.

### Data Collection

A compendium of Affymetrix HU-133A microarrays for human B cells or T cells was collected from GEO and Array Express as training samples. The accession numbers of the compendium include E-MEXP-313, GSE1577, GSE1729, GSE3912, GSE4698, GSE5820, GSE5821, GSE5822. The drug vincristine (VCR) was tested on 173 patients and samples resistant or sensitive to the drug were identified using a drug-sensitivity assay [16]. Microarrays of drug-resistant and drug-sensitive samples were collected from GEO with the accession numbers GSE635, GSE647, GSE651, GSE656, GSE660. Drug-resistant samples were used as testing samples and drug-sensitive samples as control samples.

### Results

The top 100 VCR-resistance and VCR-sensitive related genes were identified using MNI. VCR resistant-only therapeutic target genes, obtained by taking the difference between these two gene lists, shown in Table 1, were used for the subsequent analyses. Ingenuity pathway analysis was applied to identify the enriched pathways based upon the 66 genes. As a result, four pathways, including cell cycle, cell growth and proliferation, and cell death related pathways, were significantly enriched at a p-value less than 10e-10 (Table 2). These pathways are known to be involved in cancer development [17]. In particular, the cell cycle has been found to mediate drug resistance to combination drug therapy for cancer [18]. Interestingly, three enriched pathways, pathways #1, 2, and 4 shown in Table 2, are all related to cell cycle, indicating that cell-cycle-related genes may be involved in VCR resistance.

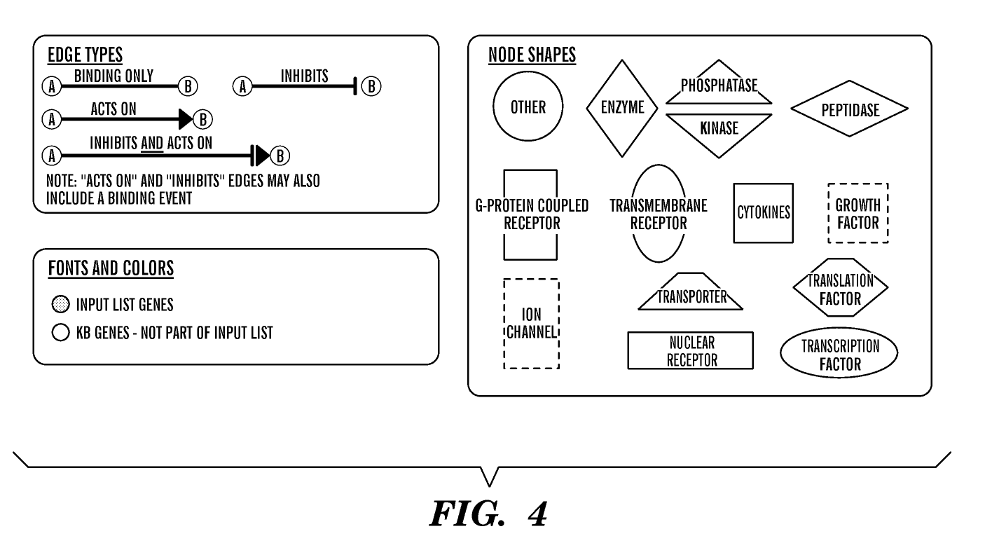

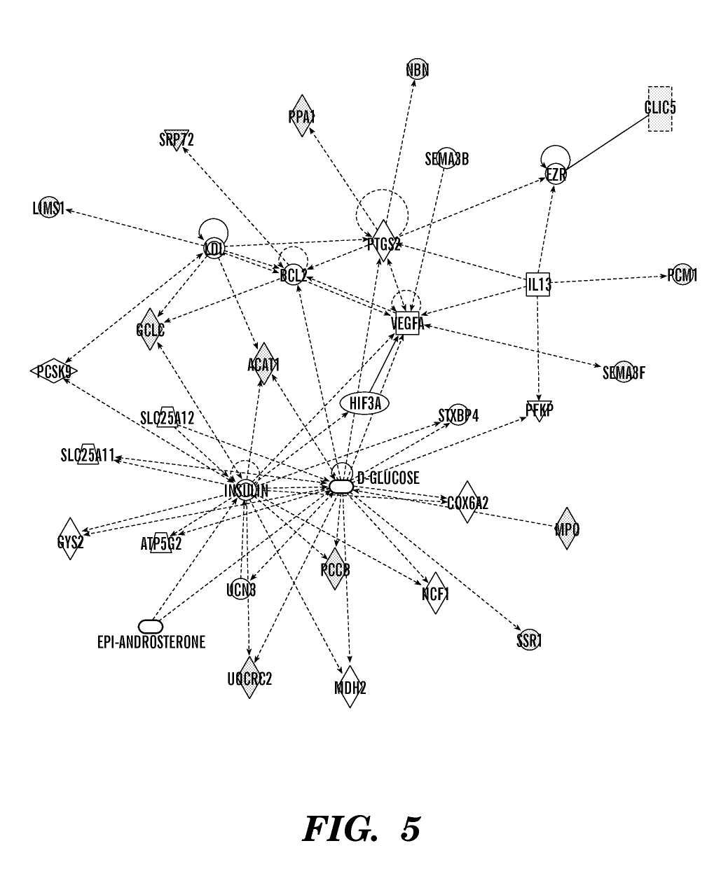

The cell death related pathway (pathway #3) was also significantly enriched. Cell death has been known to be involved in drug resistance, e.g., cancer cells can develop mechanisms to escape apoptosis and thus become resistant to chemotherapy [2]. The cell death related network is illustrated in FIG. 5 using the notations and symbols of FIG. 4. Within the network, Bcl-2 is a known anti-apoptotic gene. It is thought to be involved in resistance to conventional cancer treatment with a role for decreased apoptosis in the pathogenesis of cancer [19]. Two genes, MPO (203949_at) and GCLC (202923_at), were found to connect to Bcl-2 based upon known expression change correlations in the Ingenuity knowledge database. MPO (203949_at) encodes myeloperoxidase which is involved in the pathways of metabolic degradation of vincristine. MPO has been known to degrade vincristine in ALL cells when H₂O₂ is present, and thus induces vincristine resistance [20]. Therefore chemical inhibitors of MPO, such as taurine (T) or acetaminophen (APAP), or RNAi targeting MPO could potentially be used in combination with vincristine for ALL treatment to improve its drug sensitivity. In addition, GCLC (202923_at) encodes enzyme glutathione cysteine ligase catalytic subunit which is involved in the de novo synthesis of glutathione. Glutathione is an important molecule balancing the intracellular reactive oxygen species (ROS), which is extensively involved in signaling pathways leading to drug resistance. Over-expression of GCLC has been found to induce drug resistance in ovarian cancers [21]. Thus chemical inhibitors of GCLC (buthionine sulfoximine) or RNAi targeting GCLC could be potentially combined with vincristine to sensitize ALL cells. Therefore, the therapeutic targets listed in Table 1 include known mediators relevant to drug resistance. The other genes can be tested in ALL cells to validate their roles in vincristine drug resistance.

### Example 2

### Case Study: RNAi Combination Therapy for Hepatocellular Carcinoma

Hepatocellular carcinoma (HCC) is one of the most frequently occurring solid tumors and the third leading cause of death from cancer. It can be induced by various factors, including aflatoxin B, hepatitis B, hepatitis C, and alcohol use. Many possible pathways and factors may be involved, such as mutation of tumor suppressor genes TP53 and RB1, and accumulation of reactive oxygen species which triggers signaling pathways regulating cell proliferation, cell death and cell cycle [22]. The objective of this study was to identify mediator genes that modulate cancerous phenotypes in HCC. The identified mediator genes could serve as therapeutic targets for RNAi combination therapy.

### Data Collection

A compendium of 1963 Affymetrix HU-133A microarrays for healthy tissues and different human cancers, such as prostate cancer, breast cancer, leukemia, colon cancer, lung cancer, were collected from GEO and Array Express as training samples. Twenty HepG2 samples were collected as testing samples and five healthy liver tissues were collected as control samples.

### Results

The top 300 HepG2 and normal liver tissue related genes were identified using MNI. Of these, 271 genes that were HCC specific but not liver tissue specific, were used for the subsequent enrichment analysis. Some well-known HCC relevant genes, as shown in Table 3, were identified by the network biology approach. For example, the #1 ranked gene CD81 encodes a protein that facilitates the entry of HCV into the liver cells, while HCV is the most important cause of HCC [23]. The #2 ranked gene FER interacts with the WNT pathway and its silencing has been found to cause cell cycle arrest in breast cancer cells [24]. Similarly, protein kinase C alpha (PKCA) is known to be involved in the signaling pathway of PI3K and Mapkinase cascade. Its silencing has been found to increase apoptosis and reduce proliferation in HepG2 cells [25]. As listed in Table 3, most of these genes were not ranked highly based on expression change alone, indicating the advantage of this network biology approach.

Ingenuity pathway analysis was applied to systematically identify pathways associated with HCC based upon the genes identified as disease mediators. There were twelve pathways significantly enriched with a p-value less than 10e-10, as shown in Table 4. The enriched pathways include cancer, cell growth and proliferation, lipid metabolism and cell signaling related pathways. For example, pathway #4 shown in FIG. 4 includes the genes identified by MNI: APC, HUWE1, TAF1B, POLH, TAGLN2, UBE2D1, PPP4R2, CNOT4, PCYT1B, GDF10, RP2, NPAS2, TRERF1, SOAT2 and their interconnectivity based on literature evidence. These genes have been known to be involved in cancer related gene expression and cell morphology. For example, the protein encoded by the APC gene plays a critical role in several cellular processes that determine whether a cell may develop into a tumor by controlling how often a cell divides, how it attaches to other cells within a tissue, and whether a cell moves within or away from a tissue [26]. Another gene predicted by MNI, HUWE1, is known to be able to inactivate the tumor suppressor gene TP53 [27]. TP53 regulates the cell division cycle by keeping cells from growing and dividing too fast or in an uncontrolled way. HUWE1 expression was upregulated in the HCC samples, and thus serves as a good candidate for RNAi intervention.

Another pathway found to be enriched by our analysis was pathway #2, cellular assembly and organization, cell cycle, cellular development, illustrated in FIG. 5. It is known that genetic and epigenetic alterations in HCC inactivate cell cycle regulation by RB1 and cause constitutive activity of the WNT signaling pathway [28]. Inappropriate stimulation of the cell cycle is essential for uncontrolled cell proliferation [29]. Based upon our analysis, genes were found in pathway #2 connecting to the cell cycle regulator gene Rb1 and the cell survival pathway gene Akt (FIG. 5). For example, SMARCA2 (206543_at, #78 ranked by MNI) is functionally related to Rb1; loss of core SWI-SNF subunits of SMARCA2 renders cancer cells resistant to activation of the RB pathway by the chemotherapeutic agent cisplatin [30]. The expression level of SMARCA2 is upregulated in the HCC HepG2 samples, and thus it is a potential candidate of RNAi therapy. In the same network, THPO (21115_s_at, #4 ranked by MNI) activates Akt, which is known to be a component in the PI3K/Akt survival pathway. The THPO protein has also been found to be involved in cell migration and chemoinvasion [31]. The expression of THPO is also upregulated in HCC HepG2 samples, making it another potential candidate of RNAi therapy. One could, in principle, design RNAi combination therapies targeting SMARCA2 and THPO.

Described herein is a systematic approach for identifying disease mediators and designing combination therapies using RNAi and/or drug compounds. This approach takes advantage of high-throughput microarray gene expression data and identifies therapeutic targets within the context of gene regulatory networks. Thus it allows one to take into account the systems effects of a disease and identifies combination therapies which could potentiate the therapeutic effects of single therapies using RNAi and/or drugs. This novel systems biology approach can facilitate more rational design of combination therapies for diseases that are regulated by complex pathways.

### REFERENCE LIST

The references cited herein and throughout the application are incorporated herein by reference.
1. Barabasi A L & Oltvai Z N (2004). Network Biology: Understanding the cell's functional organization. Nature Reviews Genetics, 5: 101-114.
2. Gottesman MM (2002). Mechanisms of cancer drug resistance. Annu. Rev. Med. 53: 615-627.
3. di Bernardo D et al (2005). Chemogenomic profiling on a genome-wide scale using reverse-engineered gene networks. Nature Biotechnology 23: 377-383.
4. Ergun A, Lawrence C A, Kohanski M A, Brennan T A & Collins J J. (2007) A network biology approach to prostate cancer. Molecular Systems Biology 3: 82.
5. Liao J C, Boscolo R, Yang Y L, Tran L M, Sabatti C, & Roychowdhury V P (2003). Network component analysis: reconstruction of regulatory signals in biological systems. Proc. Natl. Acad. Sci. USA 100:15522-15527.
6. Savageau M A (1969). Biochemical system analysis. Journal of Theoretical Biology 25:365-379.
7. Ni T C & Savageau M A (1996) Model assessment and refinement using strategies from biochemical systems theory: application to metabolism in human red blood cells. Journal of theoretical biology 179: 329-68.
8. Ni T C & Savageau M A (1996) Application of biochemical systems theory to metabolism in human red blood cells. Signal propagation and accuracy of representation. Journal of biological chemistry 271: 7927-7941.
9. Li S P, Tseng J J & Wang S C (2005). Reconstructing gene regulatory networks from time-series microarray data. Physica A 350: 63-69.
10. Ashburner M et al (2000) Gene Ontology: tool for the unification of biology. Nat. Genet. 25: 25-29.
11. available on the world wide web at genome.jp/kegg/
12. available on the world wide web at ingenuity.com/
13. Xing H & Gardner T S (2006). The mode-of-action by network identification (MNI) algorithm: a network biology approach for molecular target identification. Nature Protocols 1: 2551-2554.
14. available on the world wide web at ncbi.nlm.nih.gov/geo/
15. available on the world wide web at ebi.ac.uk/arrayexpress/
16. Holleman A et al (2004). Gene expression patterns in drug resistant acute lymphoblastic leukemia cells and response to treatment. NEJM, 351: 533-542.
17. Maddika S et al (2007). Cell survival, cell death and cell cycle pathways are interconnected: implications for cancer therapy. Drug Resistance Updates. 10: 13-29.
18. Shah M A and Schwartz G K (2001). Cell cycle-mediated drug resistance: An emerging concept in cancer therapy, Clinical Cancer Research, 7: 2168-2181.
19. Vaux D L, Cory S, Adams J M (1988). Bcl-2 gene promotes haemopoietic cell survival and cooperates with c-myc to immortalize pre-B cells. Nature 335:440-2.
20. Ozgen U et al (2003). Degradation of vincristine by myeloperoxidase and hypochlorous acid in children with acute lymphoblastic leukemia. Leukemia Research, 27: 1109-1113.
21. Das G C, Bacsi A, Shrivastav M, Hazra T K & Boldog I (2006). Enhanced g-Glutamylcysteine Synthetase Activity Decreases Drug-Induced Oxidative Stress Levels and Cytotoxicity. Molecular Carcinogenesis, 45: 635-647.
22. Farazi P A & DePinho R A (2006). Hepatocellular carcinoma pathogenesis: from genes to environment. Nature Reviews Cancer, 6:674-687.
23. Lindenbach B D et al (2005). Complete Replication of Hepatitis C Virus in Cell culture. Science 309: 623-626.
24. Pasder O et al (2006) Downregulation of Fer induces PP1 activation and cell-cycle arrest in malignant cells. Oncogene 25: 4194-4206.
25. Wu T, Hsieh Y H, Hsieh Y S & Liu J Y (2007). Reduction of pkc-a decreases cell proliferation, migration, and invasion of human malignant hepatocellular carcinoma, Journal of cellular biochemistry 103: 9-20.
26. van Es J H, Giles R H, Clevers H C (2001). The many faces of the tumor suppressor gene APC. Exp Cell Res 264: 126-34.
27. Yoon S Y et al (2005) Over-expression of human UREB1 in colorectal cancer: HECT domain of human UREB1 inhibits the activity of tumor suppressor p53 protein, Biochemical and Biophysical Research Communications, 326: 7-17
28. Murphree A L and Benedict W F (1984). Retinoblastoma: clues to human oncogenesis. Science, 223 (4640): 1028-1033. (available on the world wide web at en.wikipedia.org/wiki/Entrez)
29. Bartek J and Lukas J (2001) Cell cycle: order from destruction, Science, 294(5540): 66-67.
30. Strobeck M W et al (2002). Compensation of BRG-1 function by Brm: insight into the role of the core SWI-SNF subunits in retinoblastoma tumor suppressor signaling. J. Biol. Chem. 277: 4782-922.
31. Romanelli R G et al (2006) Thrombopoietin stimulates migration and activates multiple signaling pathways in hepatoblastoma cells. AJP—Gastrointesinal and Liver Physiology 290:G120-8.

All references cited throughout this specification are herein incorporated by reference in their entirety.

### Tables

TABLE 1
Vincristine Drug Sensitivity Therapeutic Targets Related to ALL

| rank | index | probe_id | symbol |
|---|---|---|---|
| 1 | 11654 | 212268_at | SERPINB1 |
| 2 | 8133 | 208636_at | ACTN1 |
| 3 | 1091 | 201563_at | SORD |
| 4 | 17153 | 217788_s_at | GALNT2 |
| 5 | 11653 | 212267_at | WAPAL |
| 6 | 11945 | 212560_at | C11orf32 |
| 7 | 11737 | 212352_s_at | TMED10 |
| 8 | 2928 | 203401_at | PRPS2 |
| 9 | 8313 | 208818_s_at | COMT |
| 10 | 11634 | 212248_at | MTDH |
| 11 | 3646 | 204119_s_at | ADK |
| 12 | 419 | 200891_s_at | SSR1 |
| 13 | 21204 | 221844_x_at | — |
| 14 | 17320 | 217955_at | BCL2L13 |
| 15 | 3001 | 203474_at | IQGAP2 |
| 16 | 11449 | 212063_at | CD44 |
| 17 | 8211 | 208716_s_at | TMCO1 |
| 18 | 16290 | 216920_s_at | TRGC2 |
| 19 | 840 | 201312_s_at | SH3BGRL |
| 20 | 17273 | 217908_s_at | IQWD1 |
| 21 | 15179 | 215806_x_at | TRGC2 |
| 22 | 8296 | 208801_at | SRP72 |
| 23 | 1387 | 201859_at | PRG1 |
| 24 | 2452 | 202923_s_at | GCLC |
| 25 | 542 | 201014_s_at | PAICS |
| 26 | 5560 | 206033_s_at | DSC3 |
| 27 | 11985 | 212600_s_at | UQCRC2 |
| 28 | 11358 | 211971_s_at | LRPPRC |
| 29 | 12079 | 212694_s_at | PCCB |
| 30 | 4939 | 205412_at | ACAT1 |
| 31 | 3767 | 204240_s_at | SMC2 |
| 32 | 11650 | 212264_s_at | WAPAL |
| 33 | 17089 | 217724_at | SERBP1 |
| 34 | 5045 | 205518_s_at | CMAH |
| 35 | 8600 | 209106_at | NCOA1 |
| 36 | 14312 | 214937_x_at | PCM1 |
| 37 | 3019 | 203492_x_at | CEP57 |
| 38 | 5757 | 206231_at | KCNN1 |
| 39 | 18168 | 218804_at | TMEM16A |
| 40 | 8266 | 208771 _s_at | LTA4H |
| 41 | 19230 | 219866_at | CLIC5 |
| 42 | 5411 | 205884_at | ITGA4 |
| 43 | 12072 | 212687_at | LIMS1 |
| 44 | 16792 | 217427_s_at | HIRA |
| 45 | 1360 | 201832_s_at | PAK1///VDP |
| 46 | 1083 | 201555_at | MCM3 |
| 47 | 18337 | 218973_at | EFTUD1 |
| 48 | 17354 | 217989_at | DHRS8 |
| 49 | 17360 | 217995_at | SQRDL |
| 50 | 3476 | 203949_at | MPO |
| 51 | 3265 | 203738_at | C5orf22 |
| 52 | 8159 | 208662_s_at | TTC3 |
| 53 | 11978 | 212593_s_at | PDCD4 |
| 54 | 10427 | 210980_s_at | ASAH1 |
| 55 | 3020 | 203493_s_at | CEP57 |
| 56 | 6358 | 206832_s_at | SEMA3F |
| 57 | 8328 | 208833_s_at | ATXN10 |
| 58 | 18501 | 219137_s_at | C2orf33 |
| 59 | 2436 | 202907_s_at | NBN |
| 60 | 5488 | 205961_s_at | PSIP1 |
| 61 | 3944 | 204417_at | GALC |
| 62 | 13153 | 213773_x_at | NSUN5 |
| 63 | 473 | 200945_s_at | SEC31L1 |
| 64 | 19335 | 219971_at | IL21R |
| 65 | 17852 | 218487_at | ALAD |
| 66 | 17213 | 217848_s_at | PPA1 |

TABLE 2
Significantly Enriched Pathways of VCR Resistance-
only Genes Based on Ingenuity Pathway Analysis

| | P-value | Top Functions |
|---|---|---|
| 1 | 10e−28 | Cell Cycle, Cellular Growth and Proliferation, |
| | | Carbohydrate Metabolism |
| 2 | 10e−25 | Cell Cycle, Cellular Movement, Connective |
| | | Tissue Development and Function |
| 3 | 10e−25 | Cell Death, Neurological Disease, Molecular Transport |
| 4 | 10e−21 | Cell Cycle, Reproductive System Development and |
| | | Function, Cancer |

TABLE 3
Some Therapeutic Targets Identified for HCC.

| | MNI Ranking | Expression change |
|---|---|---|
| CD81 | 1 | 19 |
| FER | 2 | 2076 |
| HUWE | 8 | 3951 |
| DAGK | 22 | 7427 |
| IKBAP | 24 | 802 |
| NOX1 | 31 | 3889 |
| PLC | 36 | 2842 |
| PPAR-a | 89 | 6843 |
| PKCA | 179 | 2816 |
| TRAF | 183 | 1433 |
| PARP | 198 | 1802 |
| APC | 250 | 14286 |
| RBL1 | 258 | 3073 |

TABLE 4
Significantly Enriched Pathways in HCC
Based on Ingenuity Pathway Analysis

| | P-Value | Top Functions |
|---|---|---|
| 1 | 10e−46 | Cellular Development, Hematological System Development |
| | | and Function, Immune Response |
| 2 | 10e−46 | Cellular Assembly and Organization, Cell Cycle, |
| | | Cellular Development |
| 3 | 10e−34 | Lipid Metabolism, Small Molecule Biochemistry, Amino |
| | | Acid Metabolism |
| 4 | 10e−22 | Cancer, Gene Expression, Cell Morphology |
| 5 | 10e−16 | Cell Morphology, Skeletal and Muscular System |
| | | Development and Function, Cellular Development |
| 6 | 10e−16 | Gene Expression, Organismal Development, Skeletal and |
| | | Muscular System Development and Function |
| 7 | 10e−16 | Cancer, Neurological Disease, Cellular Growth and |
| | | Proliferation |
| 8 | 10e−14 | Lipid Metabolism, Small Molecule Biochemistry, Cellular |
| | | Development |
| 9 | 10e−14 | Cellular Development, Cellular Growth and Proliferation, |
| | | Hematological System Development and Function |
| 10 | 10e−14 | Small Molecule Biochemistry, Organismal Injury and |
| | | Abnormalities, Tumor Morphology |
| 11 | 10e−12 | Cancer, Cell Death, Reproductive System Disease |
| 12 | 10e−12 | Cell Signaling, Molecular Transport, Vitamin and |
| | | Mineral Metabolism |

1. A method for identifying candidate disease mediator genes, the method comprising the steps of:
(a) filtering a test gene expression data set from a sample representing a disease population through a reverse engineered gene regulatory network derived for an organism to identify a set of candidate target genes;
(b) assigning a z-score to each target gene in said set of candidate target genes, and ranking said target genes according to z-score, wherein increasing z-scores correlate with increasing likelihood of direct participation in disease pathology;
(c) enriching those target genes with the highest z-scores for those most likely to be directly involved in said disease using gene ontology enrichment analysis or pathway database search, wherein said enriching identifies a set of candidate disease-mediator genes.

2. The method of claim 1, wherein said reverse engineered gene regulatory network is derived from a compendium of gene expression data sets derived from said organism.

3. The method of claim 1, wherein said reverse engineered gene regulatory network is constructed using the steps of:
(a) providing a biological system or a plurality of biological systems, each biological system comprising a biological network comprising a plurality of biochemical species having activities;
(b) perturbing the activity of at least one of the biochemical species, thereby causing a response in the biological network;
(c) allowing the biological network to reach a steady state;
(d) determining the response of at least one of the biochemical species in the biological network; and
(e) estimating parameters of a model representing the biological network, whereby said reverse-engineered gene regulatory network is constructed.

4. The method of claim 1, wherein said compendium of gene expression data sets comprises gene expression data from a plurality of conditions of said organism.

5. The method of claim 1, wherein said pathway database search comprises searching pathway maps or applying a pathway analysis.

6. The method of claim 1, further comprising targeting a candidate disease-mediator gene of said set of candidate disease-mediator genes for modulation with an agent.

7. The method of claim 1, further comprising targeting a candidate disease-mediator gene of said set of candidate disease-mediator genes for modulation with a plurality of agents.

8. The method of claim 6, comprising targeting a plurality of candidate disease-mediator genes for modulation with an agent, or a plurality of agents.

9. The method of claim 6, wherein said modulation comprises inhibition of said candidate disease-mediator gene.

10. The method of claim 9, wherein said inhibition comprises treating a subject with an agent selected from the group consisting of an RNA interference molecule, a small molecule, an antibody or antigen-binding fragment thereof, a peptide, a polypeptide, an oligonucleotide, an aptamer, a peptide nucleic acid, or a nucleic acid.

11. The method of claim 1 wherein said enriching those target genes with the highest z-scores comprises enriching a set of 100 to 300 genes with the highest z-scores.

12. A method for predicting synergistic drug combinations for treating a given disease, the method comprising the steps of:
(a) filtering a test gene expression data set from a sample derived from an individual or set of individuals treated with a first drug through a reverse engineered gene regulatory network derived for an organism to identify a set of candidate genes influenced by said first drug,
(b) assigning a z-score to each candidate gene in said set of candidate genes, and ranking said candidate genes according to z-score, wherein increasing z-scores correlate with increasing likelihood of direct influence by treatment with said first drug;
(c) enriching those candidate genes with the highest z-scores using gene ontology enrichment analysis or pathway database search, wherein said enriching provides an enriched set of candidate drug-influenced genes, and
wherein said enriched set of candidate drug-influenced genes represents potential therapy targets that are predicted to have a combined efficacy for treating a given disease that is greater than the added efficacy of each agent alone.

13. The method of claim 12, wherein said reverse engineered gene regulatory network is derived from a compendium of gene expression data sets derived from said organism.

14. The method of claim 12, wherein said reverse engineered gene regulatory network is constructed using the steps of:
(a) providing a biological system or a plurality of biological systems, each biological system comprising a biological network comprising a plurality of biochemical species having activities;
(b) perturbing the activity of at least one of the biochemical species, thereby causing a response in the biological network;
(c) allowing the biological network to reach a steady state;
(d) determining the response of at least one of the biochemical species in the biological network; and
(e) estimating parameters of the model.

15. The method of claim 12, wherein said compendium of gene expression data sets comprises gene expression data from a plurality of conditions of said organism.

16. The method of claim 12, wherein said pathway database search comprises searching pathway maps or applying a pathway analysis.

17. The method of claim 12, further comprising targeting a candidate disease-mediator gene of said set of candidate disease-mediator genes for modulation with an agent.

18. The method of claim 12, comprising targeting a plurality of candidate disease-mediator genes for modulation with an agent, or a plurality of agents.

19. The method of claim 17, further comprising targeting a candidate disease-mediator gene of said set of candidate disease-mediator genes for modulation with a plurality of agents.

20. The method of claim 17, wherein said modulation comprises inhibition of said candidate disease-mediator gene.

21. The method of claim 20, wherein said inhibition comprises treating a subject with an agent selected from the group consisting of an RNA interference molecule, a small molecule, an antibody or antigen-binding fragment thereof, a peptide, a polypeptide, an aptamer, a peptide nucleic acid, an oligonucleotide, or a nucleic acid.

22-83. (canceled)

84. A computer-readable medium comprising computer-executable instructions for identifying a set of candidate disease mediator genes, said medium comprising:
(a) instructions for receiving test gene expression data from a sample representing a disease population of an organism;
(b) instructions for filtering said test gene expression through a reverse engineered gene regulatory network derived for said organism to identify a set of candidate target genes;
(c) instructions for assigning a z-score to each target gene in said set of candidate target genes, and ranking said target genes according to z-score, wherein increasing z-scores correlate with increasing likelihood of direct participation in disease pathology;
(d) instructions for enriching those target genes with the highest z-scores for those most likely to be directly involved in said disease using gene ontology enrichment analysis or pathway database search, wherein said enriching identifies a set of candidate disease-mediator genes; and
(e) instructions for outputting the identities of said set of candidate disease-mediator genes to a computer-readable memory or to an output device.

85. A computer system for identifying candidate disease mediator genes, the computer system comprising:
(a) a user interface;
(b) a computer processor capable of executing computer executable instructions encoded on a computer-readable medium;
(c) a computer readable medium comprising:
(i) instructions for receiving test gene expression data from a sample representing a disease population of an organism;
(ii) instructions for filtering said test gene expression through a reverse engineered gene regulatory network derived for said organism to identify a set of candidate target genes;
(iii) instructions for assigning a z-score to each target gene in said set of candidate target genes, and ranking said target genes according to z-score, wherein increasing z-scores correlate with increasing likelihood of direct participation in disease pathology;
(iv) instructions for enriching those target genes with the highest z-scores for those most likely to be directly involved in said disease using gene ontology enrichment analysis or pathway database search, wherein said enriching identifies a set of candidate disease-mediator genes; and
(v) instructions for outputting the identities of said set of candidate disease-mediator genes to a computer-readable memory or to said user interface.

86. A computer-readable medium comprising computer-executable instructions for predicting synergistic drug combinations for treating a given disease, the medium comprising:
(a) instructions for receiving a test gene expression data set from a sample derived from an individual or set of individuals treated with a first drug;
(b) instructions for filtering said gene expression data set through a reverse engineered gene regulatory network derived for an organism to identify a set of candidate genes influenced by said first drug;
(c) instructions for assigning a z-score to each candidate gene in said set of candidate genes, and for ranking said candidate genes according to z-score, wherein increasing z-scores correlate with increasing likelihood of direct influence by treatment with said first drug;
(d) instructions for enriching those candidate genes with the highest z-scores using gene ontology enrichment analysis or pathway database search, wherein said enriching provides an enriched set of candidate drug-influenced genes, and wherein said enriched set of candidate drug-influenced genes represents potential therapy targets that are predicted to have a combined efficacy for treating a given disease that is greater than the added efficacy of each agent alone; and
(e) instructions for outputting the identities of said set of candidate drug-influenced genes to a computer-readable memory or to an output device.

87. A computer system for predicting synergistic drug combinations for treating a given disease, the system comprising:
(a) a user interface;
(b) a computer processor capable of executing computer executable instructions encoded on a computer-readable medium;
(c) a computer readable medium comprising:
(i) instructions for receiving a test gene expression data set from a sample derived from an individual or set of individuals treated with a first drug;
(ii) instructions for filtering said gene expression data set through a reverse engineered gene regulatory network derived for an organism to identify a set of candidate genes influenced by said first drug;
(iii) instructions for assigning a z-score to each candidate gene in said set of candidate genes, and for ranking said candidate genes according to z-score, wherein increasing z-scores correlate with increasing likelihood of direct influence by treatment with said first drug;
(iv) instructions for enriching those candidate genes with the highest z-scores using gene ontology enrichment analysis or pathway database search, wherein said enriching provides an enriched set of candidate drug-influenced genes, and wherein said enriched set of candidate drug-influenced genes represents potential therapy targets that are predicted to have a combined efficacy for treating a given disease that is greater than the added efficacy of each agent alone; and
(v) instructions for outputting the identities of said set of candidate drug-influenced genes to a computer-readable memory or to an output device.

88-91. (canceled)
